(19) United States
(12) Patent Application Publication
(10) Pub. No.: US 2007/0204275 A1
(43) Pub. Date: Aug. 30, 2007

(54) METHOD AND SYSTEM FOR RELIABLE MESSAGE DELIVERY

(75) Inventors: Melanie A. Alshab, Indianapolis, IN (US); Peter J. Bales, St. Peters, MO (US); Robert D. Covington, Evansville, IN (US); Jonathan D. Theophilus, Indianapolis, IN (US); Lisa M. Trotter, Fishers, IN (US)

Correspondence Address: BAKER & DANIELS LLP, 300 NORTH MERIDIAN STREET, SUITE 2700, INDIANAPOLIS, IN, 46204, US

(73) Assignee: Rhysome, Inc., Indianapolis, IN (US)

(21) Appl. No.: 11/467,756

(22) Filed: Aug. 28, 2006

Related U.S. Application Data
(60) Provisional application No. 60/712,231, filed on Aug. 29, 2005.

(51) Int. Cl. G06F 9/46

(52) U.S. Cl. 719/313

(57) ABSTRACT

The present invention guarantees that messages in a distributed computing environment are successfully delivered from an application sending data to an application receiving the data by maintaining a fault tolerant message delivery system in the event of system failure. This method of reliable message delivery uses at least four separate computing devices that communicate with each other via a Local Area Network. Each computing device has its own Receiver, Message Queue, and Transmitter, referred to as a Node, which are used for message transport. Each message is held in at least two Message Queues on two computing devices at one time until the message is successfully delivered to its final destination.

This application claims the benefit of U.S. Provisional Patent Application Ser. No. 60/712,231 filed Aug. 29, 2005, the complete disclosure of which is hereby expressly incorporated by reference.

### BACKGROUND OF THE INVENTION

1. Field of the Invention

The described invention relates to a fault tolerant Message Delivery System in a distributed computing environment.

2. Related Art

Messaging is a technology that enables high-speed, asynchronous, program-to-program communication with reliable delivery. Programs communicate by sending packets of data called messages to each other. Channels, also known as queues, are logical pathways that connect the programs and convey messages. A channel behaves like a collation or array of messages, but one that is shared across multiple computers and can be used concurrently by multiple applications. A sender or producer is a program that sends a message by writing the message to a channel. A receiver or consumer is a program that receives a message by reading (and deleting) it from a channel.

Traditional guaranteed messaging buses have two modes of operation: persistent and non-persistent. In a non-persistent mode, the message is placed in a queue by a client and the messaging middleware guarantees delivery to the other end. If there is a hardware, software, or communication failure during the middle of the transaction, the transaction is lost.

In a persistent mode, the messages are written to the disk on both the client and the server as they are put into the message queue. Once the transactions are complete, the messages are purged from the disks. Since writing to disks is a synchronous operation, performance is significantly reduced (less than 1,000 messages per second on most hardware platforms) and suffers from unreliability in the event of any failure in the process.

In a non-persistent mode, traditional messaging systems store messages in memory until they can successfully forward the message to the next storage point. When the message is sent to one message queue and acknowledged by that message queue, it is deleted from memory. This is reliable as long as the messaging system is running reliably, but if the messaging system is unexpectedly unavailable (for example, because one of its computers loses power or the messaging process aborts unexpectedly), all of the messages stored in memory are lost. If there is a failure with the server where the message is being stored in memory before it is successfully acknowledged by the receiving message queue, the message is lost and unrecoverable.

Most traditional applications have to deal with similar problems. All data that is stored in memory is lost if the application crashes. To prevent this, traditional applications use files and databases to persist data to disk so that the data survives system crashes. Messaging systems need a similar way to persist messages more permanently so that no message gets lost, even if the system crashes.

With guaranteed delivery, a traditional messaging system uses a built-in datastore to persist messages. Each computer on which the messaging system is installed has its own datastore so that messages can be stored locally. When the sender sends a message, the send operation does not complete successfully until the message is safely stored in the sender's datastore. Subsequently, the message is not deleted from one datastore until it is successfully forwarded to and stored in the next datastore. In this way, once the sender successfully sends the message, it is always stored on disk on at least one computer until it is successfully delivered to and acknowledged by the receiver.

Persistence increases reliability but at the expense of performance. Thus, if it is acceptable to lose messages when the messaging system crashes or is shut down, enterprises avoid using guaranteed delivery so messages will move through the messaging system faster.

Traditional guaranteed delivery can consume a large amount of disk space in high-traffic scenarios. If a producer generates hundreds of thousands of messages per second, then a network outage that lasts multiple hours could use up a huge amount of disk space. Because the network is unavailable, the messages have to be stored on the producing computer's local disk drive, which may not be designed to hold this much data. For these reasons, some messaging systems allow you to configure a retry timeout parameter that specifies how many messages are buffered inside the messaging system. In some high-traffic applications (e.g., streaming stock quotes to terminals), this timeout may have to be set to a short time span, for example, a few minutes. Luckily, in many of these applications, messages are used as event messages and can safely be discarded after a short amount of time elapses.

The message itself is simply some sort of data structure—such as a string, a byte array, a record, or an object. It can be interpreted simply as data, as the description of a command to be invoked on the receiver, or as the description of an event that occurred in the sender. A message actually contains two parts, a header and a body. The header contains meta-information about the message—who sent it, where it is going, and so on; this information is used by the messaging system and is mostly ignored by the applications using the messages. The body contains the application data being transmitted and is usually ignored by the messaging system.

### SUMMARY OF THE INVENTION

The present invention involves a communications system which stores messages only until acknowledgements are sent. With a plurality of devices capable of communicating messages between a source and a destination, a node of the present invention comprises a transmitter, receiver, and queue with logic. The transmitter is capable of sending a message over the communications system to another device. The receiver is capable of receiving a message from the communications system sent by another device. The queue stores the data messages, and includes logic circuitry capable of obtaining a data message or an acknowledgment message from the receiver. When a data message is received it is stored in the queue and an acknowledgement message is sent by the transmitter. When an acknowledgement message is received then a data message stored in the queue is deleted.

The logic circuitry may use path information from a data message to send the data message to a device indicated by the path information. Alternatively, the said logic circuitry may use a list of available devices to determine where to send the data message. The logic circuitry may further determine an identifier from a data message and delete duplicate identifiers from the queue. The logic circuitry may also include a clock capable of timing the storage of data messages wherein after a predetermined time period the logic circuitry deletes data messages in the queue. The logic circuitry may send a plurality of copies of a data message via the transmitter, and the logic circuitry may maintain the data message in the queue until acknowledgement messages are received for each copy of the data message sent. The logic circuitry may conduct point-to-point or asynchronous communications.

The method of sending a data message between devices in a communications network is comprised of the following steps: receiving a data message, storing a copy of the data message in a queue, transmitting a copy of the data message to another device, and deleting the copy of the data message in the queue when an acknowledgement message is received. The transmitting step may include targeting a device based on path information related to the data message. The transmitting step may include targeting a device based on a list of available devices. The storing step may include determining an identifier for the data message and only storing the data message if the associated identifier is not duplicative in the queue. The transmitting step may further include the step of timing the storage time of data messages in the queue and retransmitting data messages that are in the queue greater than a predetermined amount of time. The transmitting step may further include transmitting a plurality of copies of the data message, wherein deletion only occurs after an acknowledgement message is received from each copy of the data message sent. The receiving and transmitting steps may involve point-to-point or asynchronous communications.

A messaging system is needed to move messages from one computer to another because computers and the networks that connect them are inherently unreliable (e.g.; network not available, hardware failure on a computer, etc.). Just because one application is ready to send data does not mean that the other application is ready to receive it. Even if both applications are ready, the network may not be working or may fail to transmit the data properly. A messaging system overcomes these limitations by repeatedly trying to transmit the message until it succeeds. Under ideal circumstances, the message is transmitted successfully on the first try, but circumstances are often not ideal. This automatic retry enables the messaging system to overcome problems with the network so that the sender and receiver do not have to worry about these details.

A message is transmitted in five steps: a) the sender creates the message and populates it with data—create, b) the sender adds the message to a channel—send, c) the messaging system moves the message from the sender's computer, making it available to the receiver—deliver, d) the receiver reads the message from the channel—receive, and e) the receiver extracts the data from the message—process.

These steps illustrate two important messaging concepts. a) In step b, the sending application sends the message to the message channel. Once that send is complete, the sender can go on to other work while the messaging system transmits the message in the background. The sender can be confident that the receiver will eventually receive the message and does not have to wait until that happens. This is referred to as the send-and-forget process. b) In step b, when the sending application sends the message to the message channel, the messaging system stores the message on the sender's computer, either in memory or on disk. In step c, the messaging system delivers the message by forwarding it from the sender's computer to the receiver's computer, and then stores the message once again on the receiver's computer. This store-and-forward process may be repeated many times as the message is moved from one computer to another until it reaches the receiver's computer.

The create, send, receive, and process steps may seem like unnecessary overhead. By wrapping the data as a message and storing it in the messaging system, the applications delegate to the messaging system the responsibility of delivering the data. Because the data is wrapped as an independent unit, delivery can be retried until it succeeds, and the receiver can be assumed of reliably receiving exactly one copy of the data.

The use of a store-and-forward messaging approach to transmitting messages is the reason why message systems are more reliable than traditional methods of application communication such as RPC (Remote Procedure Call). The data is packaged as messages which are independent units. When the sender sends a message, the messaging system stores the message. It then delivers the message by forwarding it to the receiver's computer, where it is stored again. Storing the message on the sender's computer and the receiver's computer is assumed to be reliable.

Message channels guarantee message delivery, but they do not guarantee when the message will be delivered. This can cause messages that are sent in sequence to get out of sequence. In situations where messages depend on each other, special care has to be taken to reestablish the message sequence.

Messaging systems do add some overhead to communications. It takes effort to package application data into a message and send it, and to receive a message and process it. If the information to be sent is very large, dividing it into numerous small pieces may not be a smart idea. For example, if an integration solution needs to synchronize information between two existing systems, the first step is usually to replicate all relevant information from one system to the other. For such a bulk data replication step, ETL (Extract, Transform, and Load) tools are much more efficient than messaging. Messaging is best suited to keeping the system synchronized after the initial data replication.

Messaging is an asynchronous technology, which enables delivery to be retried until it succeeds. In contrast, most applications use synchronous function calls—for example, a procedure calling a subprocedure, one method calling another method, or one procedure invoking another remotely through an RPC (such as CORBA and DCOM). Synchronous calls imply that the calling process is halted while the subprocess is executing a function. In contrast, when using asynchronous messaging, the caller uses a send-and-forget approach that allows it to continue to execute after it sends the message. As a result, the calling procedure continues to run while the subprocedure is being invoked.

Remote connections are not only slow, but they are much less reliable than a local function call. When a procedure calls a subprocedure inside a single application, it is given that the subprocedure is available. This is not necessarily true when communicating remotely; the remote application may not even be running or the network may be temporarily unavailable. Reliable, asynchronous communication enables the source application to go on to other work, confident that the remote application will act sometime later.

Messaging is used to transfer packets of data frequently, immediately, reliably, and asynchronously, using customizable formats. Asynchronous messaging is fundamentally a pragmatic reaction to the problems of distributed systems. Sending a message does not require both systems to be available and ready at the same time.

Messaging applications transmit data through a message channel, a virtual pipe that connects a sender to a receiver. A message is an independent packet of data that can be transmitted on a channel. The pipe and filters architecture describes how multiple processing steps can be chained together using channels. The original sender sends the message to a message router. The router then determines how to navigate the channel topology and directs the message to the final receiver, or at least to the next router. Most applications do not have any built-in capability to interface with a messaging system. Rather, they must contain a layer of code that knows both how the application works and how the messaging system works, bridging the two so that they work together. This bridge code is a set of coordinated message endpoints that enable the application to send and receive messages.

A message consists of two basic parts. a) Header—Information issued by the messaging system that describes the data being transmitted, its origin, its destination, and so on. b) Body—The data being transmitted, which is generally ignored by the messaging system and simply transmitted as is.

A message channel decouples the sender and the receiver of a message. This also means that multiple applications can publish messages to a message channel. As a result, a message channel can contain messages from different sources that may have to be treated differently based on the type of message or other criteria.

A defining property of the message router is that it does not modify the message contents; it concerns itself only with the destination of the message. The key benefit of using a message router is that the decision criteria for the destination of a message is maintained in a single location. If new message types are defined, new processing components are added, or routing rules change, only the message router logic needs to change, while all other components remain unaffected. Also, since all messages pass through a single message router, incoming messages are guaranteed to be processed one by one in the correct order. However, if the message router is not available, messages cannot be delivered to their final destination. This may cause the loss of messages since message queues are limited in size by the memory allocated to them. Once the message queue is full, all incoming messages are lost because there is no available memory in which to store them.

The message router component must have knowledge of all possible destination channels in order to send the message to the correct channel. If the list of possible destinations changes frequently, the message router can turn into a maintenance bottleneck. In other cases, it would be better to let the individual recipients decide the messages in which they are interested. This can be accomplished by using a publish-subscribe channel and an array of message filters.

The application and the messaging system are two separate sets of software. The application provides functionality for some type of user, whereas the messaging system manages messaging channels for transmitting messages for communication. Even if the messaging system is incorporated as a fundamental part of the application, it is still a separate, specialized provider of functionality, much like a database management system or a Web server. Because the application and the messaging system are separate, they must have a way to connect and work together.

A messaging system is a type of server, capable of taking requests and responding to them. Like a database accepting and retrieving data, a messaging server accepts and delivers messages. A messaging system is a messaging server.

Applications do not necessarily know how to be messaging clients any more than they know how to be database clients. The messaging server, like a database server, has a client Application Program Interface (API) that the application uses to interact with the server. The API is not application-specific but is domain-specific, where the domain is messaging. The application must contain a set of code that connects and unites the messaging domain with the application to allow the application to perform messaging. Connect an application to a messaging channel using a message endpoint, a client of the messaging system that the application can then use to send or receive messages. It is the endpoint that receives a message, extracts the contents, and gives them to the application in a meaningful way. The message endpoint encapsulates the messaging system from the rest of the application and customizes a general messaging API for a specific application and task.

One of the main advantages of asynchronous messaging over RPC is that the sender, the receiver, and network connecting the two do not all have to be working at the same time. If the network is not available, the messaging system stores the message until the network becomes available. Likewise, if the receiver is unavailable, the messaging system stores the message and retries delivery until the receiver becomes available. This is the store-and-forward process upon which messaging is based.

A message router is used to route messages between multiple destinations. It is very efficient because it can route a message directly to the correct destination. A router that can self-configure based on special configuration messages from participating destinations is called a dynamic router. Besides the usual input and output channels, the dynamic router uses an additional control channel. During system startup, each potential recipient sends a special message to the dynamic router on this control channel, announcing its presence and listing the conditions under which it can handle a message. The dynamic router stores the preferences for each participant in a rule base. When a message arrives, the dynamic router evaluates all rules and routes the message to the recipient whose rules are fulfilled. This allows for efficient, predictive routing without the maintenance dependency of the dynamic router on each potential recipient. In the most basic scenario, each participant announces its existence and routing preferences to the dynamic router at startup time. This requires each participant to be aware of the control queue used by the dynamic router. It also requires the dynamic router to store the rules in a persistent way. Otherwise, if the dynamic router fails and has to restart, it would not be able to recover the routing rules.

Many traditional messaging systems incorporate built-in mechanisms to eliminate duplicate messages so that the application does not have to worry about duplicates. However, eliminating duplicates inside the messaging infrastructure causes additional overhead. If the receiver is inherently resilient against duplicate messages, messaging throughput can be increased if duplicates are allowed. Some messaging systems only provide at-least-once delivery and let the application deal with duplicate messages. Others allow the application to specify whether or not it deals with duplicates.

An idempotent receiver is one that can safely receive the same message multiple times. The term idempotent is used in mathematics to describe a function that produces the same result if it is applied to itself: f(x)=f(f(x)). In messaging, this concept translates into a message that has the same effect whether it is received once or multiple times. This means that a message can safely be resent without causing any problems even if the receiver receives duplicates of the same message. Idempotency can be achieved through two primary means: a) explicit de-duping, which is the removal of duplicate messages, or b) defining the message semantics to support idempotency.

The recipient can explicitly de-dupe messages by keeping track of messages that it already received. A unique message identifier simplifies this task and helps detect those cases where two legitimate messages with the same message content arrive. By using a separate field, the message identifier, the semantics of a duplicate message are not tied to the message content. A unique message identifier is then assigned to each message. Many messaging systems, such as JMS-compliant messaging tools, automatically assign unique message identifiers to each message without the application having to worry about them.

In order to detect and eliminate duplicate messages based on the message identifier, the message recipient has to keep a list of already received message identifiers. One of the key design decisions is how long to keep this history of messages and whether to persist the history to permanent storage such as disk. This decision depends primarily on the contract between the sender and the receiver. In the simplest case, the sender sends one message at a time, awaiting the receiver's acknowledgement after every message. In this scenario, it is sufficient for the receiver to compare the message identifier of any incoming message to the identifier of the previous message. It will then ignore the new message if the identifier is identical. Effectively, the receiver keeps a history of a single message. In practice, this style of communication can be very inefficient, especially if the latency (the time for the message to travel from the sender to the receiver) is significant relative to the desired message throughput. In these situations, the sender may want to send a whole set of messages without awaiting acknowledgement for each one. This implies, though, that the receiver has to keep a longer history of identifiers for already received messages. The size of the receiver's “memory” depends on the number of messages the sender can send without having gotten an acknowledgement from the receiver.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIGS. 1A through 1C depict the components of one embodiment of the distributed fault-tolerant Message Delivery System;

FIGS. 2A through 2L depict a second embodiment of the present invention;

FIGS. 3A through 3P depict a third embodiment of the present invention; and

FIGS. 4A through 4I depict a fourth embodiment of the present invention.

Corresponding reference characters indicate corresponding parts. Although the drawings represent embodiments of the present invention, the drawings are not necessarily to scale and certain features may be exaggerated in order to better illustrate and explain the present invention. The exemplification set out herein illustrates embodiments of the invention, in several forms, and such exemplifications are not to be construed as limiting the scope of the invention in any manner.

### DETAILED DESCRIPTION OF THE EMBODIMENTS OF PRESENT INVENTION

The present invention is a distributed fault tolerant Message Delivery System that does not significantly affect system performance. The invention eliminates the need to persist messages to disk in the event of failure which is a significant problem with traditional message systems. Unlike traditional message systems, the present invention allows systems to communicate with each other with: a) fault tolerant message queuing, b) maintained redundancy so that data is not lost in the event of a system failure, c) higher performance than traditional disk-based persistent message delivery systems in networks through limiting communication to only the closest message queues, thereby eliminating end-to-end communication, and d) the processing of messages asynchronously, which increases the speed at which messages are processed.

The embodiments of the present invention mitigates risk associated with losing messages in the event of system or hardware failure by sending the same message to the same receiving application via at least two unique routes, which means that there are duplicate messages sent to the receiving application for each message sent from the source. The embodiments provide a process that has the message in more than one message queue at all times and eliminates the need for synchronous disk writes. The embodiments are fault tolerant while using high speed persistent storage—volatile RAM. If there is a failure at the destination before messages are processed, they can be retransmitted. Since a message is always stored in two places at once, the message is not lost in the event of failure. When messages are successfully delivered and acknowledged, any duplicate messages are discarded appropriately so that messages are not processed more than once by the receiving application. The embodiments are not limited by any brand or type of technology as long as each message queue is configured to work in a distributed network environment.

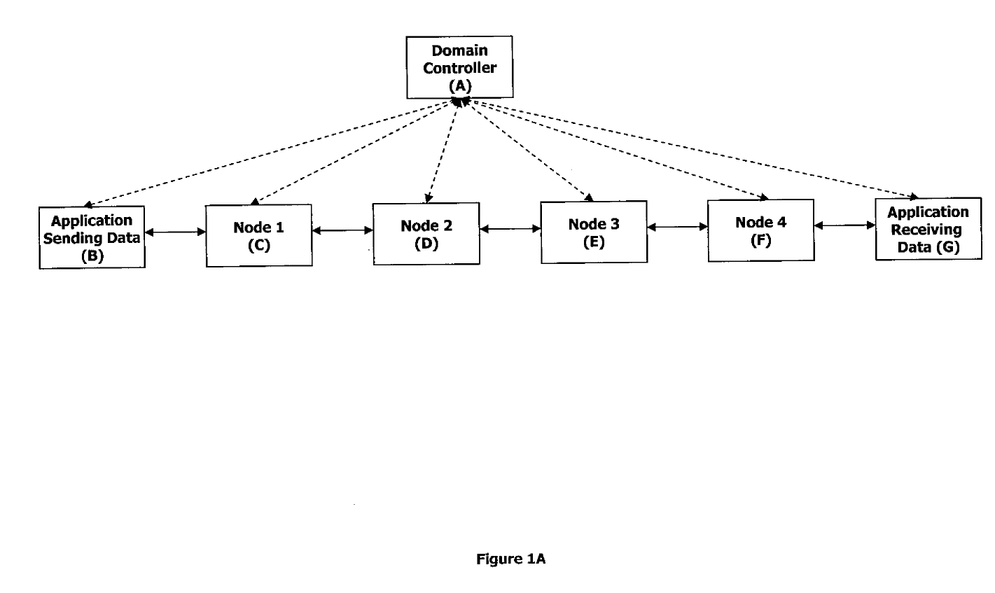

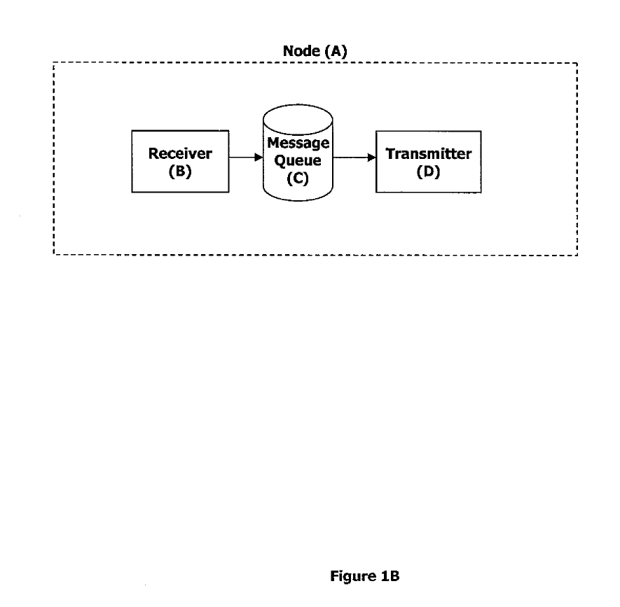

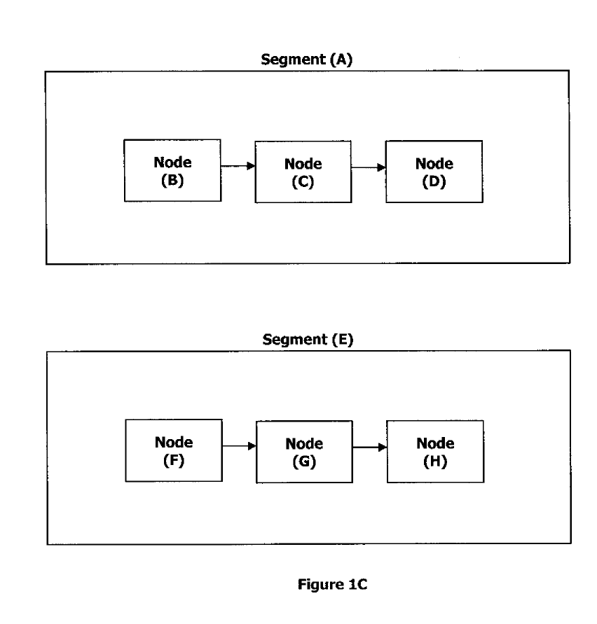

As depicted in the embodiment of FIG. 1A, the distributed fault-tolerant Message Delivery System includes Domain Controller (A), an Application Sending Data (B), Nodes (C through F), and Application Receiving Data (G). Domain Controller (A) is used to coordinate interaction between the application and associated messages. It keeps a dynamic record of all Nodes (C through F) that are available for message delivery. It periodically sends a list of available Nodes (C through F) to the Application Sending Data (B) and each Node (C through F) along with a route to the Application Receiving Data (G). Domain Controller (A) may further determine a preferred route and send the preferred route information to each Node (C through F) as either path information or as a list of available nodes. As Application Send Data (B), each Node (C through F), and Application Receiving Data (G) is attached to the Message Delivery System, it registers itself with Domain Controller (A) and Domain Controller (A) sends back all available routes. If one of Nodes (C through F) does not respond, Domain Controller (A) changes the routes and informs Application Sending Data (B) and each Node (C through F) in the Message Delivery System of the change. Domain Controller (A) is not involved in the actual message delivery. If Domain Controller (A) goes down, messages may still flow as long as the routes do not change.

As depicted in FIG. 1B, Node (A) is composed of Receiver (B), Message Queue (C), and Transmitter (D). As depicted in FIGS. 1C and 1D, Segment (A) is a series of Nodes (B though D) that communicate with each other, but do not communicate Nodes (F through H) in other Segments (E).

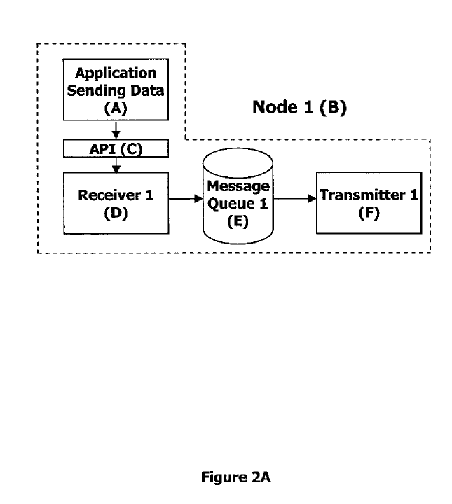

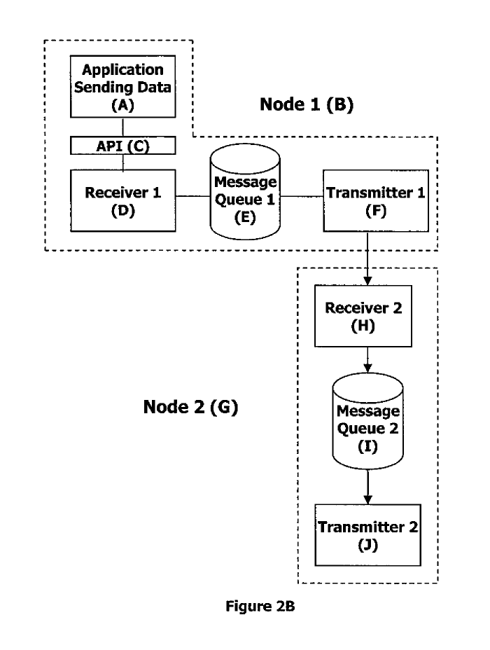

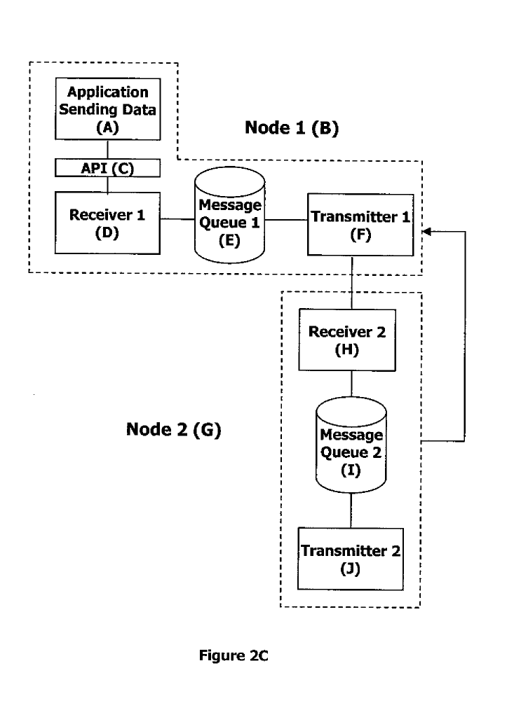

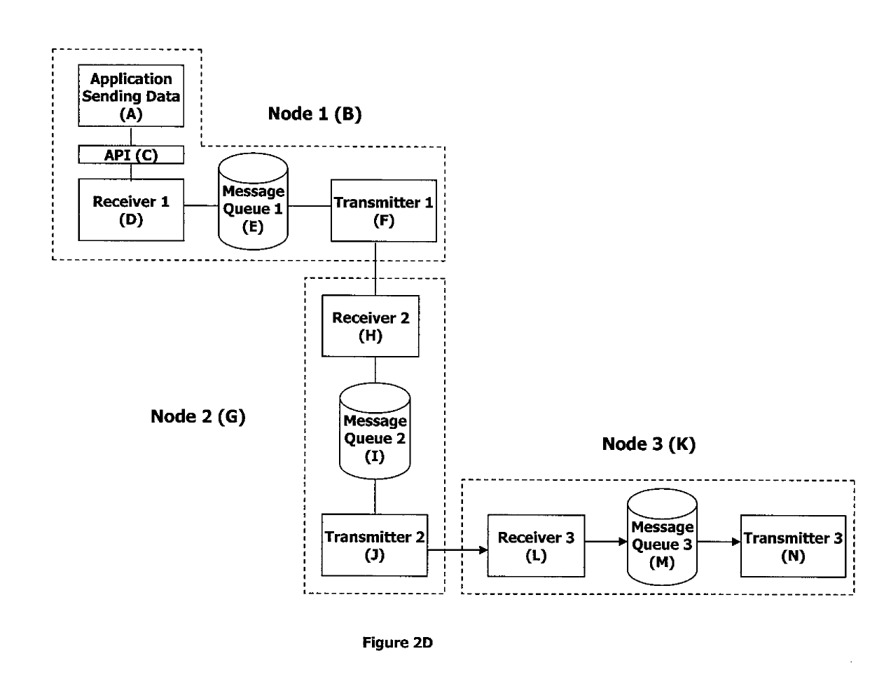

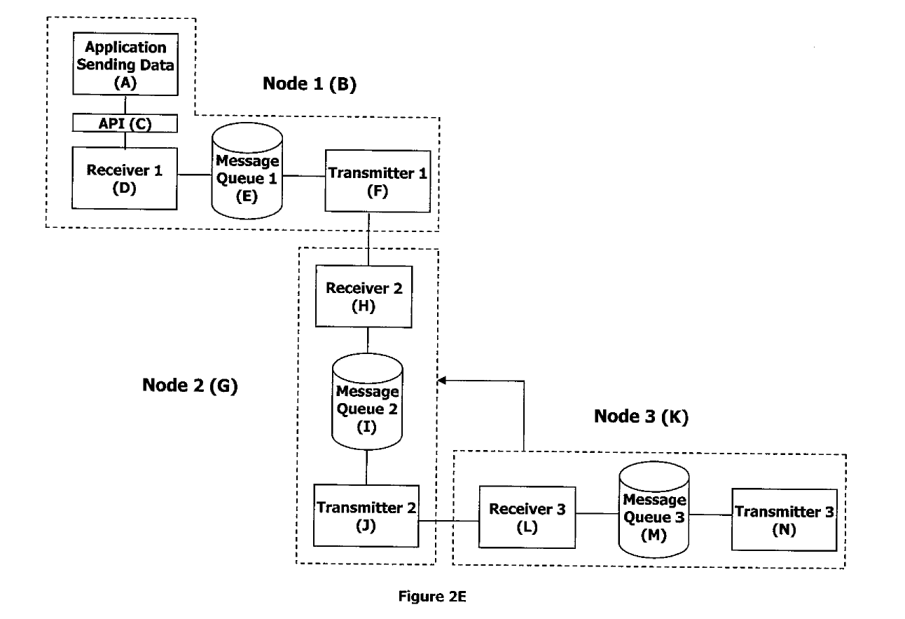

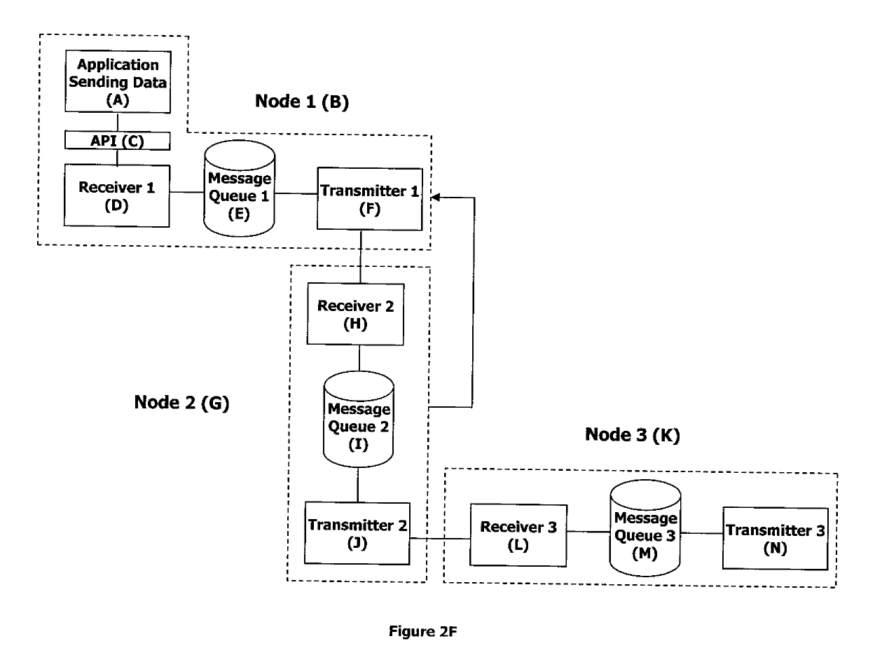

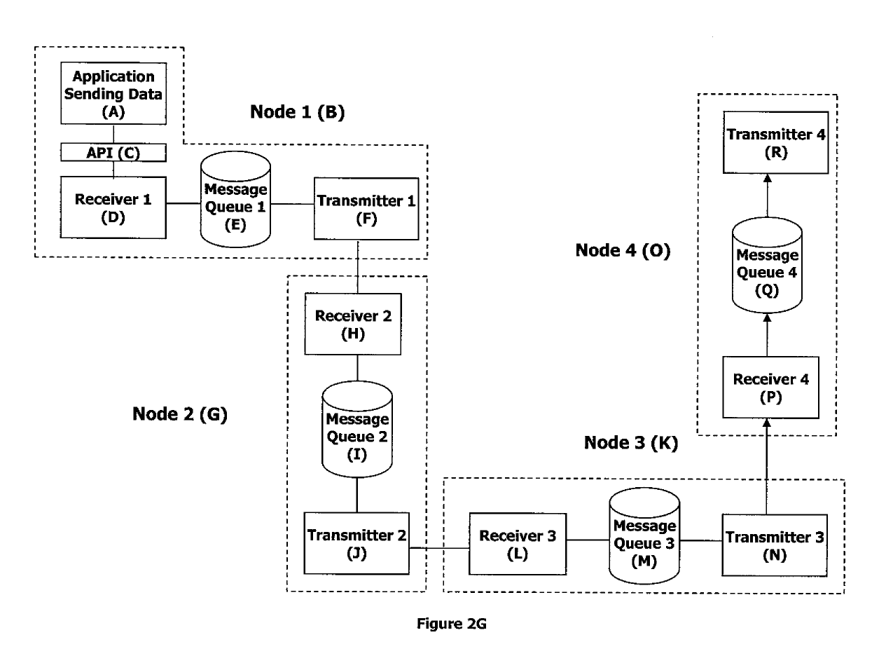

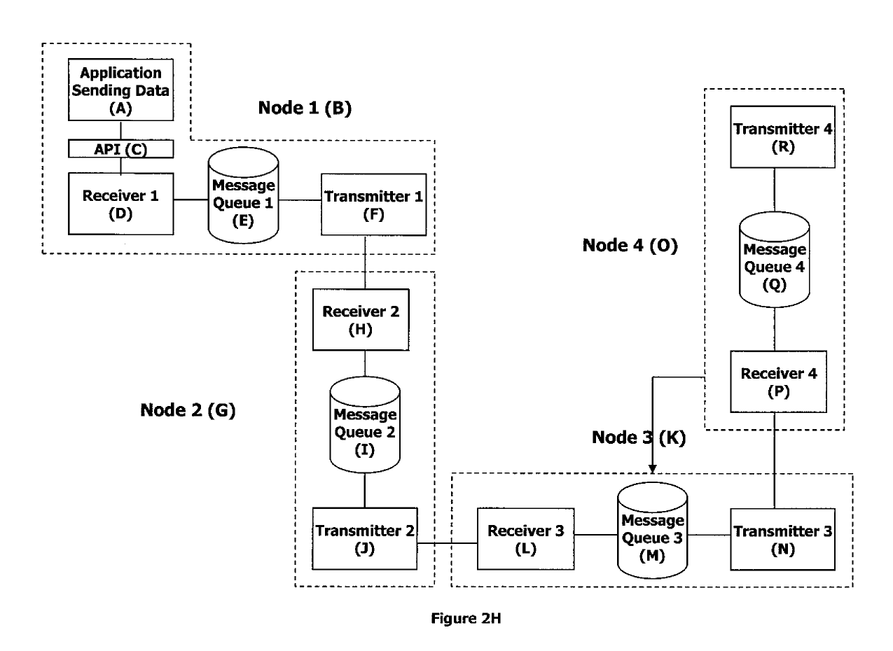

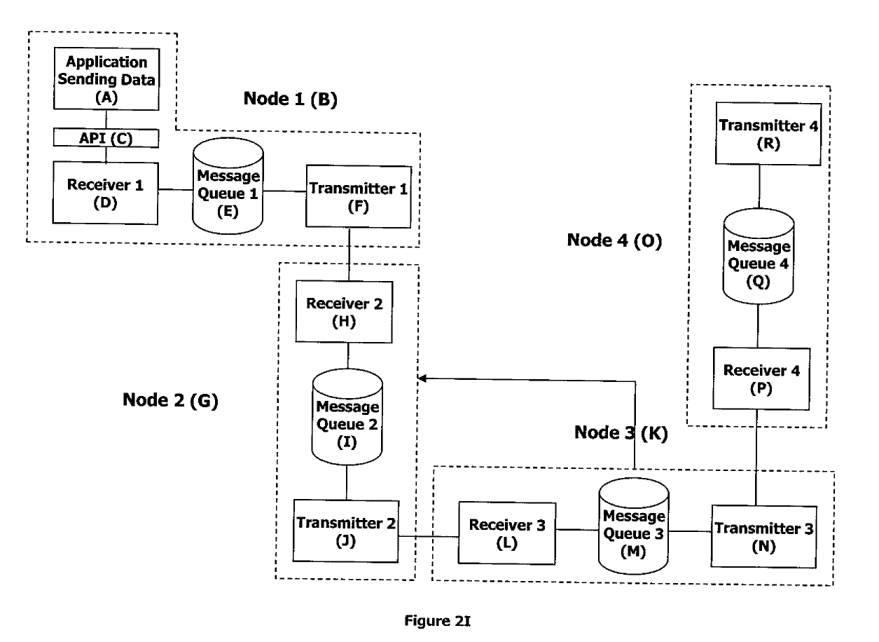

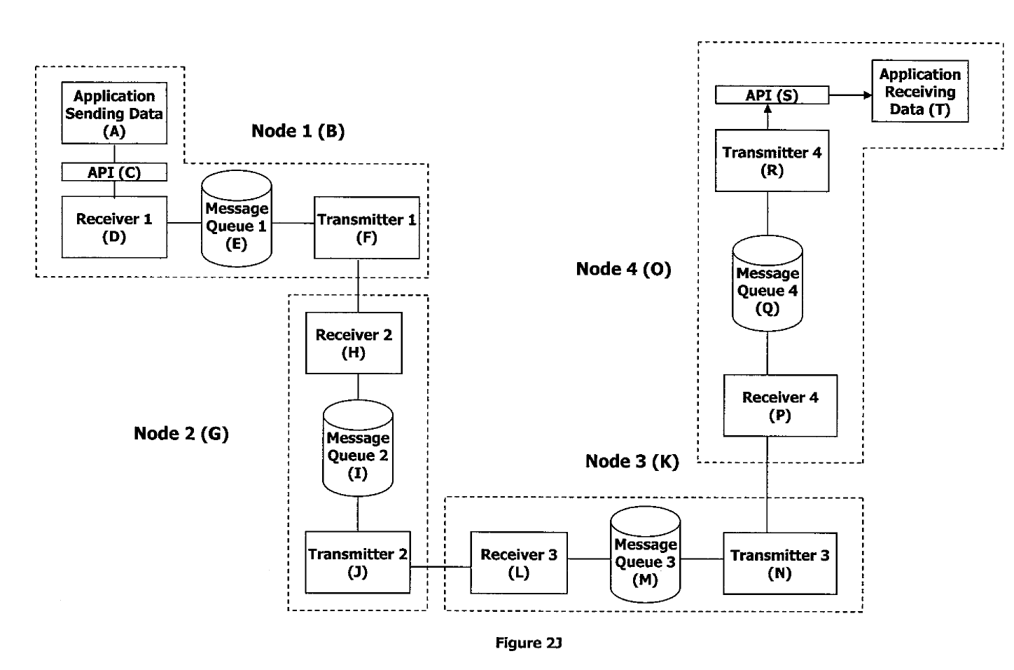

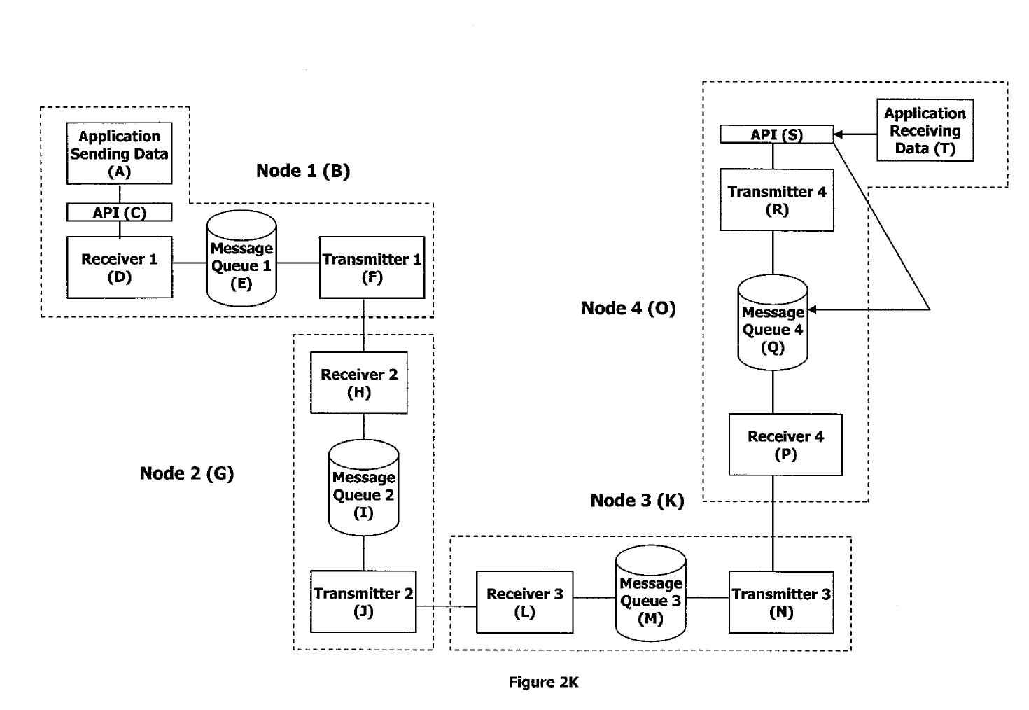

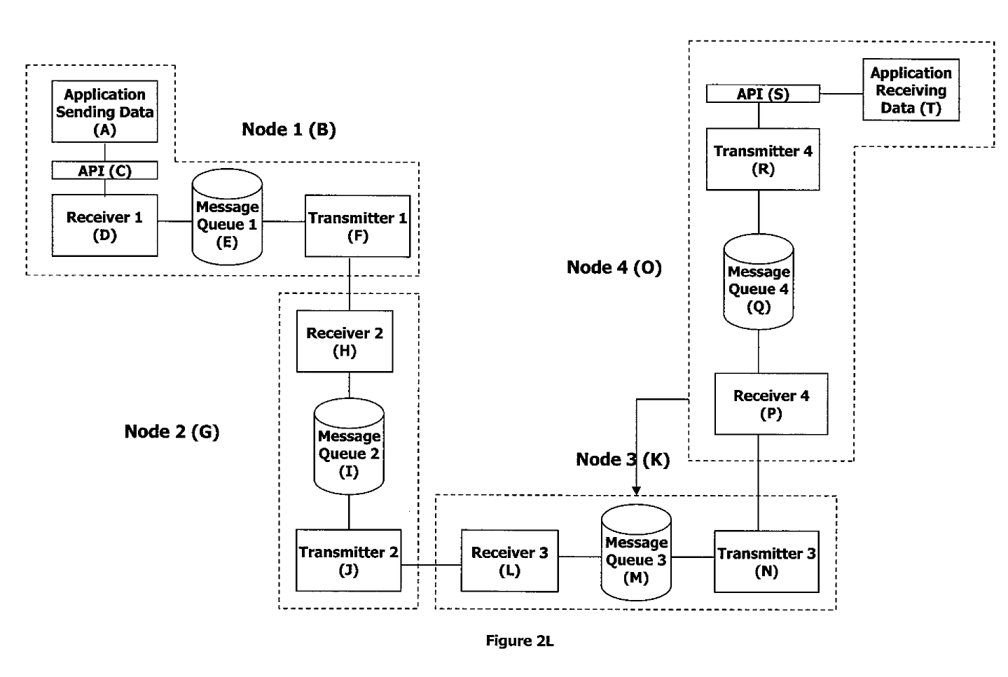

FIGS. 2A through 2L illustrate the process which one embodiment of the present invention uses to accomplish the increased reliability and speed of the reliable message delivery system. The following outlines each step of the process utilized by this method of the invention.

FIG. 2A—A message is sent from the Application Sending Data (A) to API (C) on Node 1 (B). API (C) sends the message to Receiver 1 (D) on Node 1 (B). Receiver 1 (D) sends the message to Message Queue 1 (E). Message Queue 1 (E) sends a copy of the message to Transmitter 1 (F).

FIG. 2B—Transmitter 1 (F) on Node 1 (B) sends the message to Receiver 2 (H) on Node 2 (G). Receiver 2 (H) sends the message to Message Queue 2 (I). Message Queue 2 (J) sends a copy of the message to Transmitter 2 (J).

FIG. 2C—Node 2 (G) sends Node 1 (B) an acknowledgement for the receipt of the message and Node 1 (B) marks the message in Message Queue 1 (E) as acknowledged.

FIG. 2D—Transmitter 2 (J) on Node 2 (G) sends the message to Receiver 3 (L) on Node 3 (K). Receiver 3 (L) sends the message to Message Queue 3 (M). Message Queue 3 (M) sends a copy of the message to Transmitter 3 (N).

FIG. 2E—Node 3 (K) sends Node 2 (G) an acknowledgement for receipt of the message and Node 2 (G) marks the message in Message Queue 2 (J) as acknowledged.

FIG. 2F—Node 2 (G) sends an acknowledgement to Node 1 (B) that the message is now in both Message Queue 2 (J) on Node 2 (G) and Message Queue 3 (M) on Node 3 (K). Once the acknowledgement is received by Node 1 (B), the message is removed from Message Queue 1 (E).

FIG. 2G—Transmitter 3 (N) on Node 3 (K) sends the message to Receiver 4 (P) on Node 4 (O). Receiver 4 (P) sends the message to Message Queue 4 (Q). Message Queue 4 (Q) sends a copy of the message to Transmitter 4 (R).

FIG. 2H—Node 4 (O) sends Node 3 (K) acknowledgement for receipt of the message and Node 3 (K) marks the message in Message Queue 3 (M) as acknowledged.

FIG. 2I—Node 3 (K) sends acknowledgement to Node 2 (G) that the message is now in both Message Queue 3 (M) on Node 3 (K) and Message Queue 4 (Q) on Node 4 (O). Once acknowledgement is received by Node 2 (G), the message is removed from Message Queue 2 (I).

FIG. 2J—Transmitter 4 (R) on Node 4 (O) sends the message to the API (S) on Node 4 (O). API (S) sends the message to Application Receiving Data (T).

FIG. 2K—Application Receiving Data (T) sends acknowledgement to Node 4 (O) that the message has been successfully delivered. The message is deleted from Message Queue 4 (Q) on Node 4 (O).

FIG. 2L—Node 4 (N) sends acknowledgement to Node 3 (J) that the message has been successfully delivered to Application Receiving Data (R). The message is deleted from Message Queue 3 (L) on Node 3 (J).

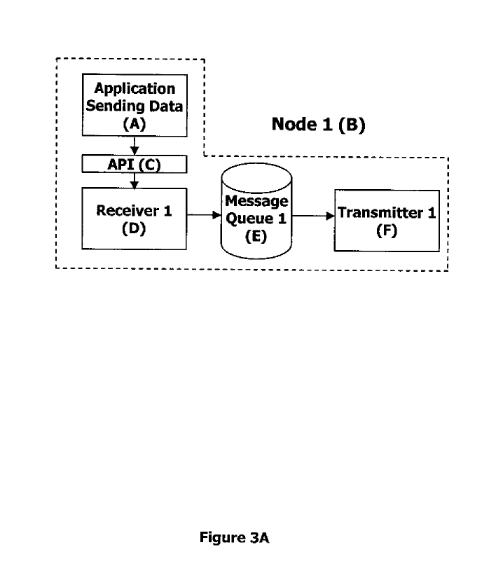

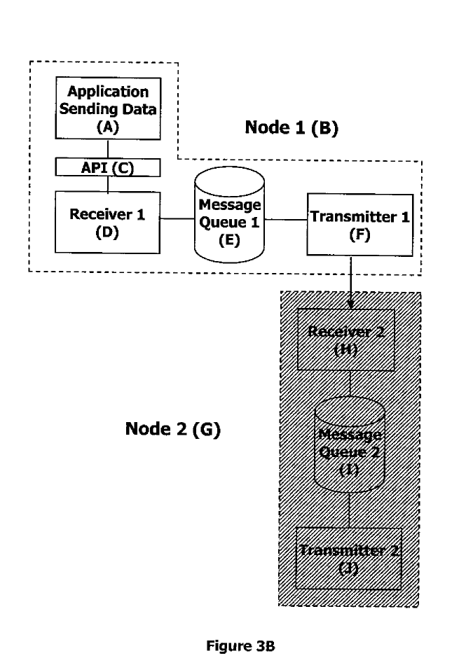

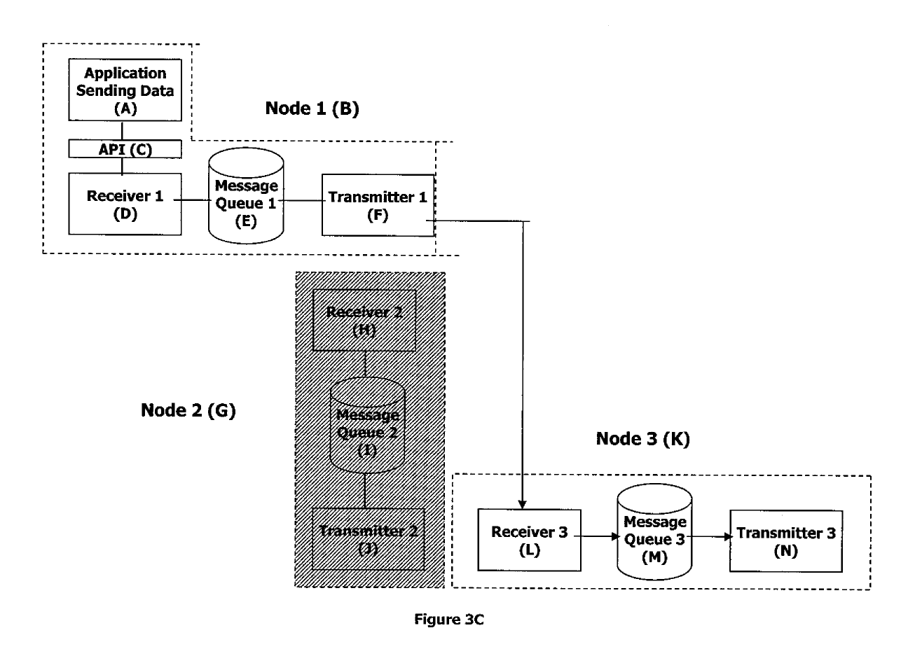

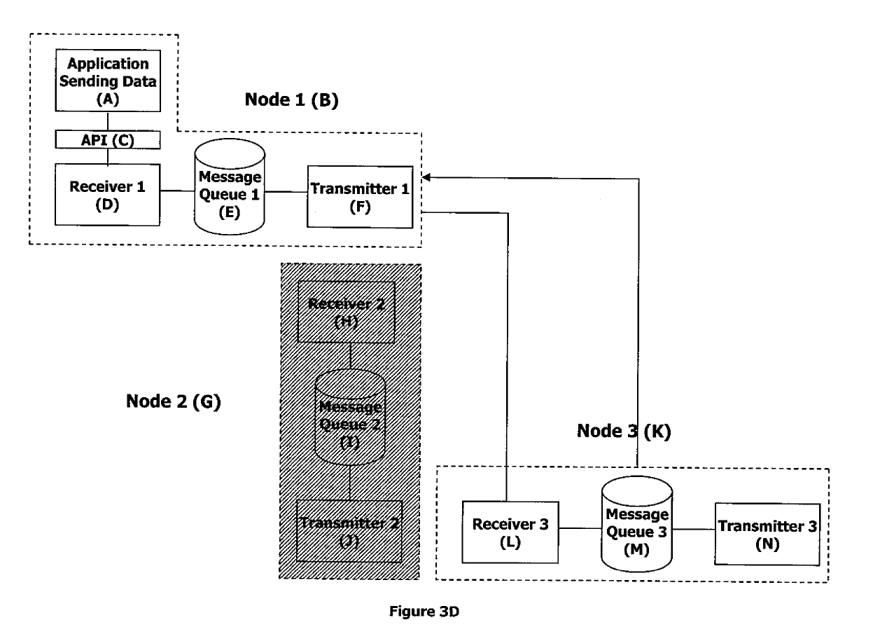

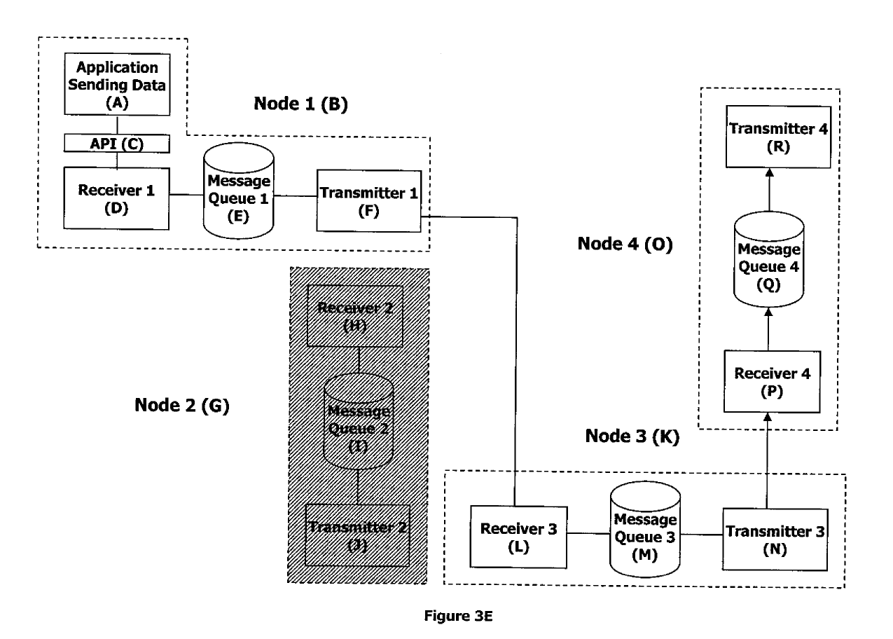

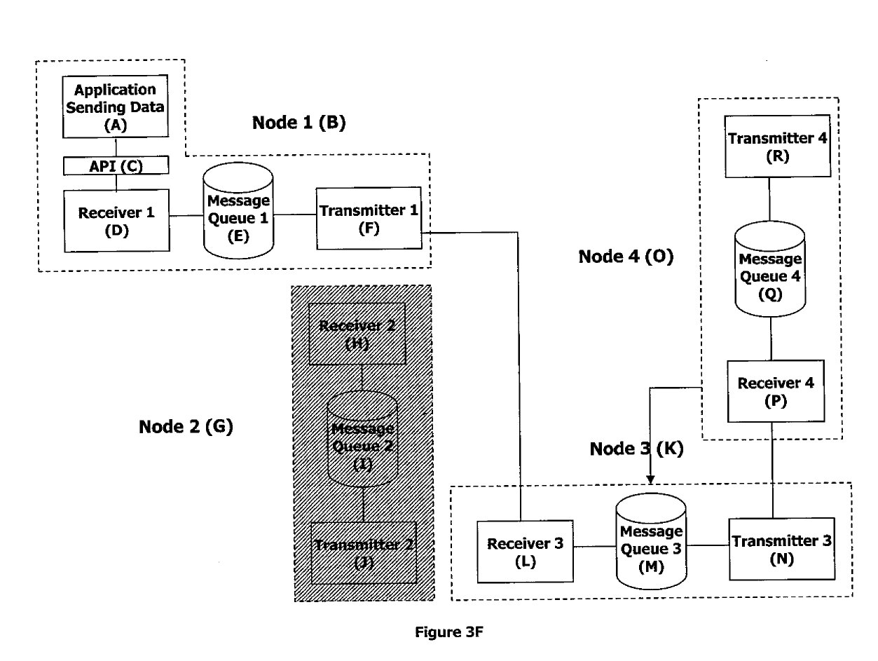

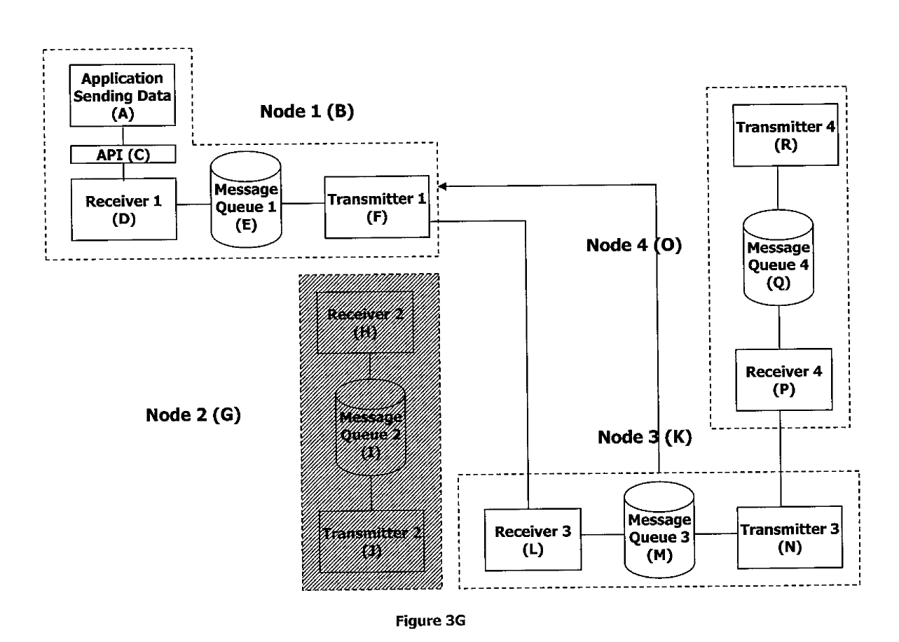

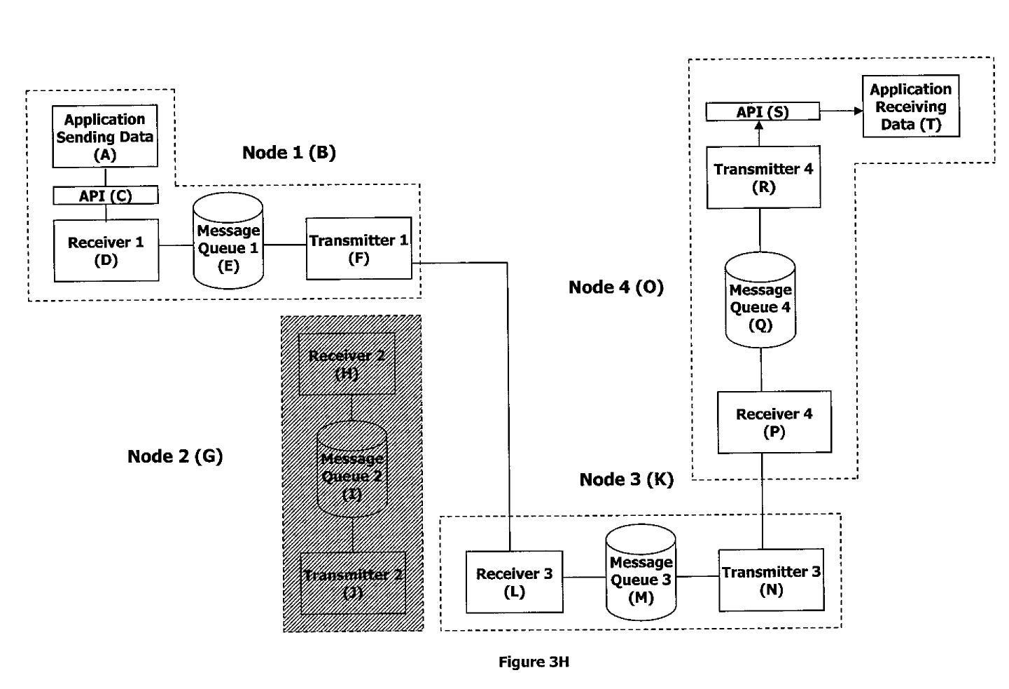

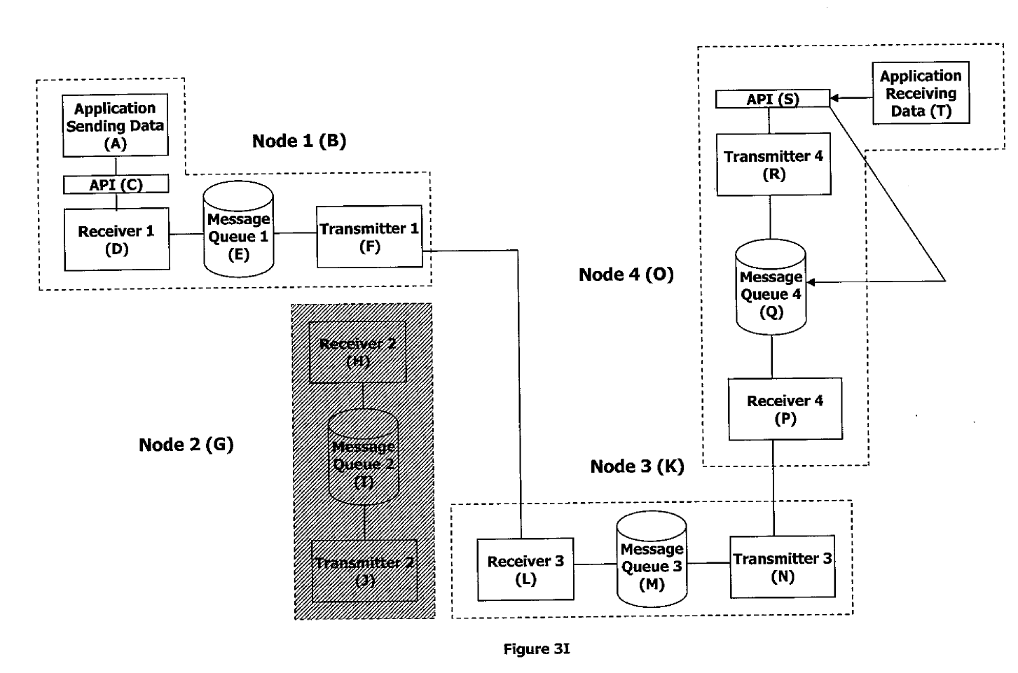

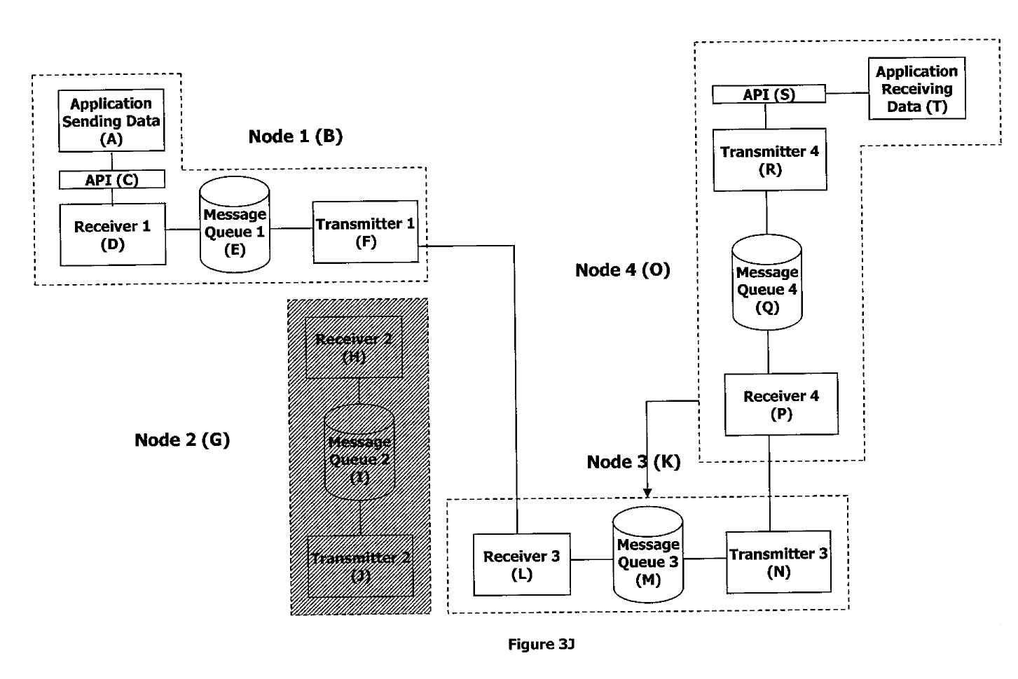

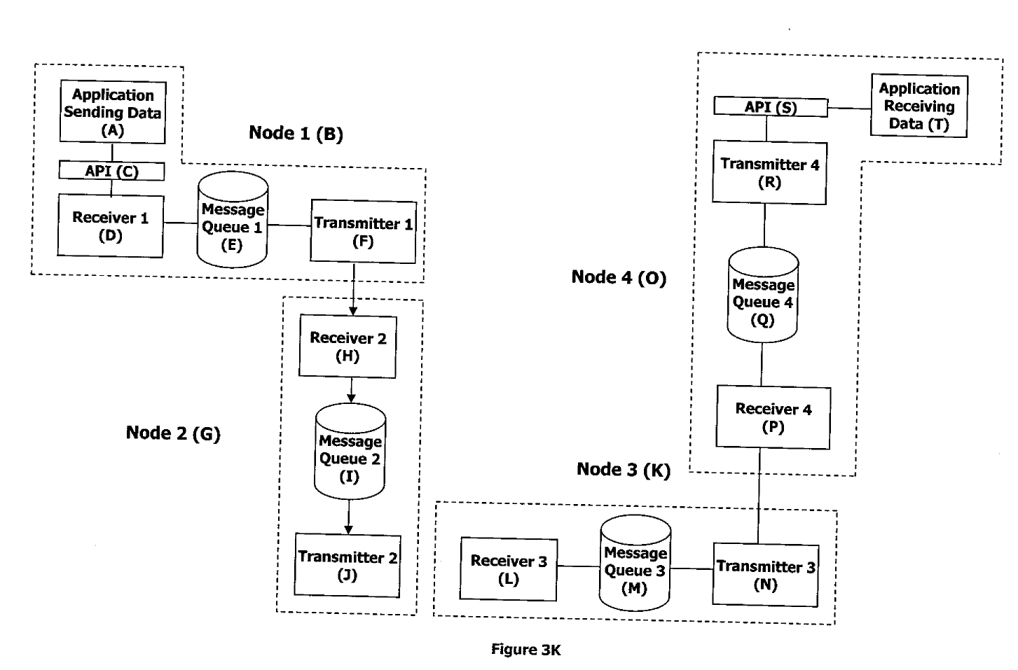

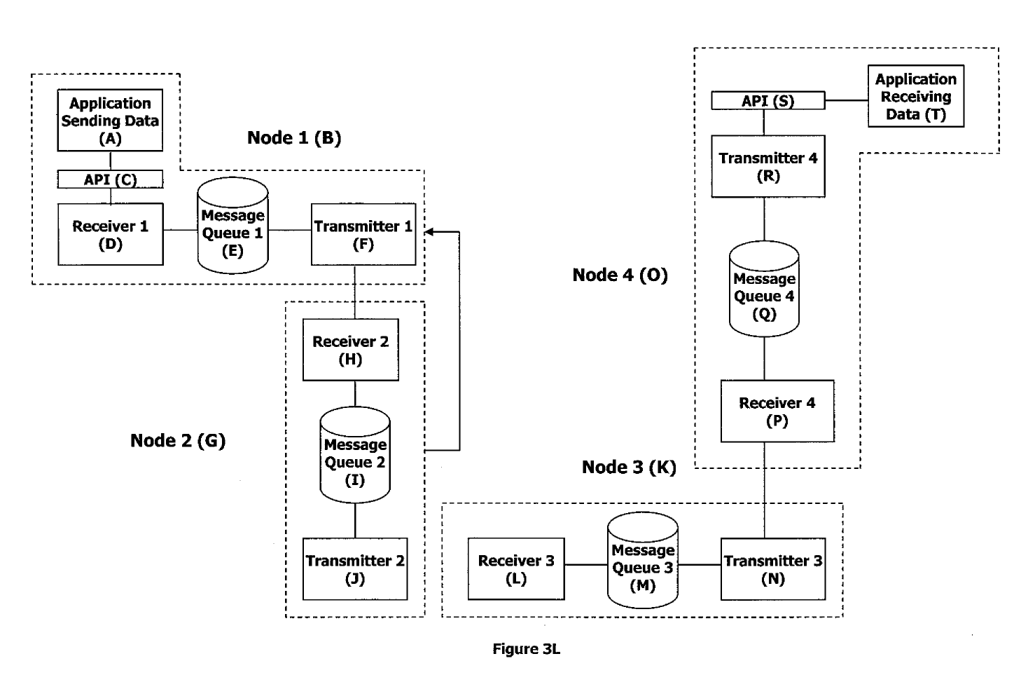

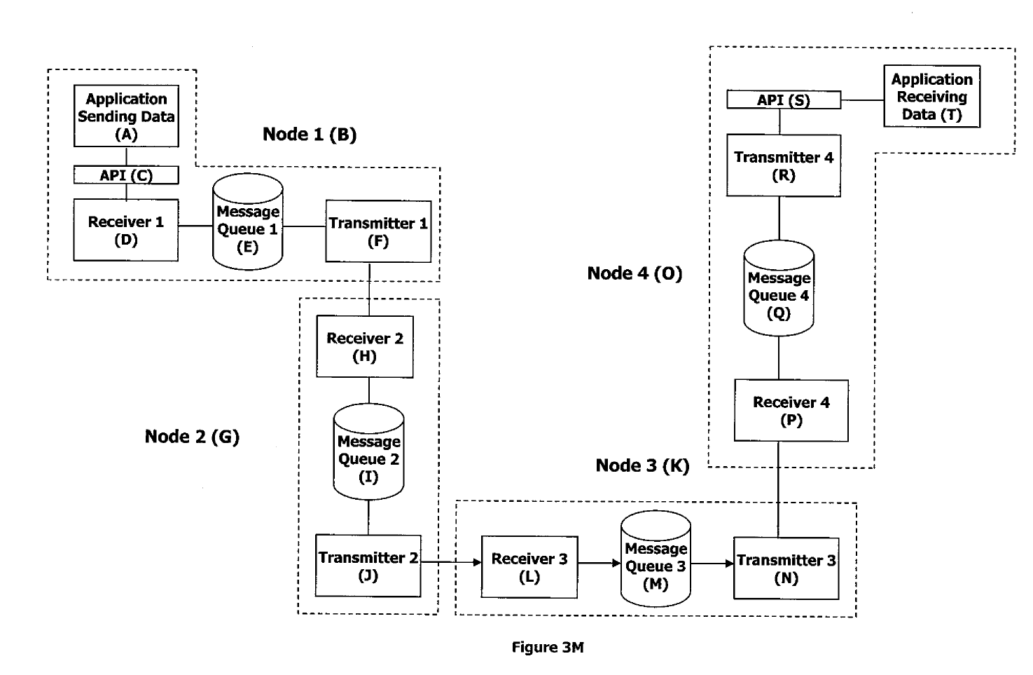

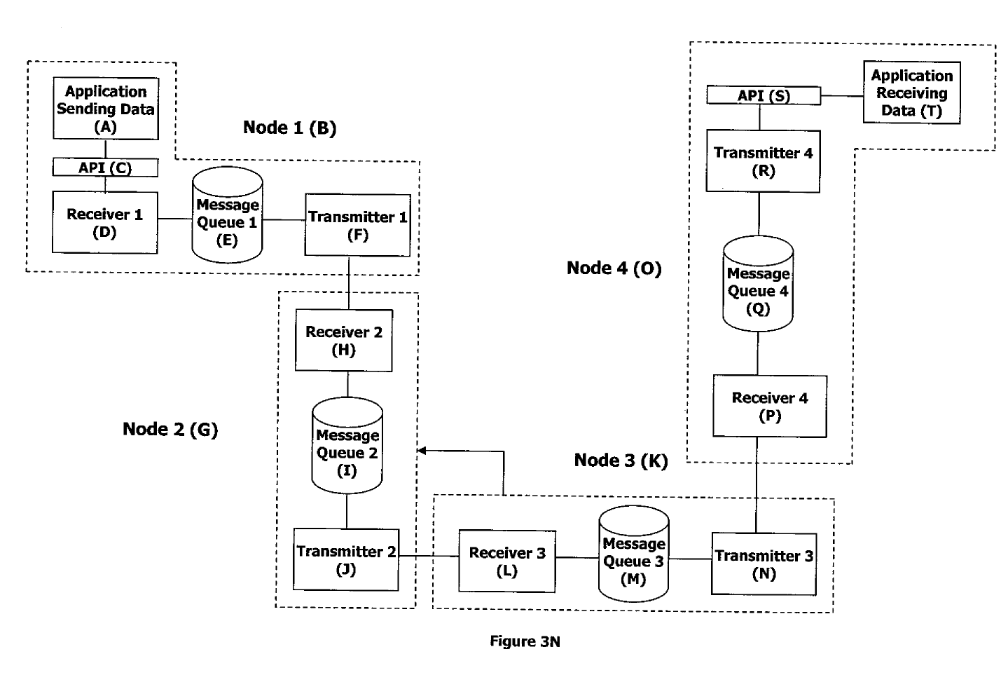

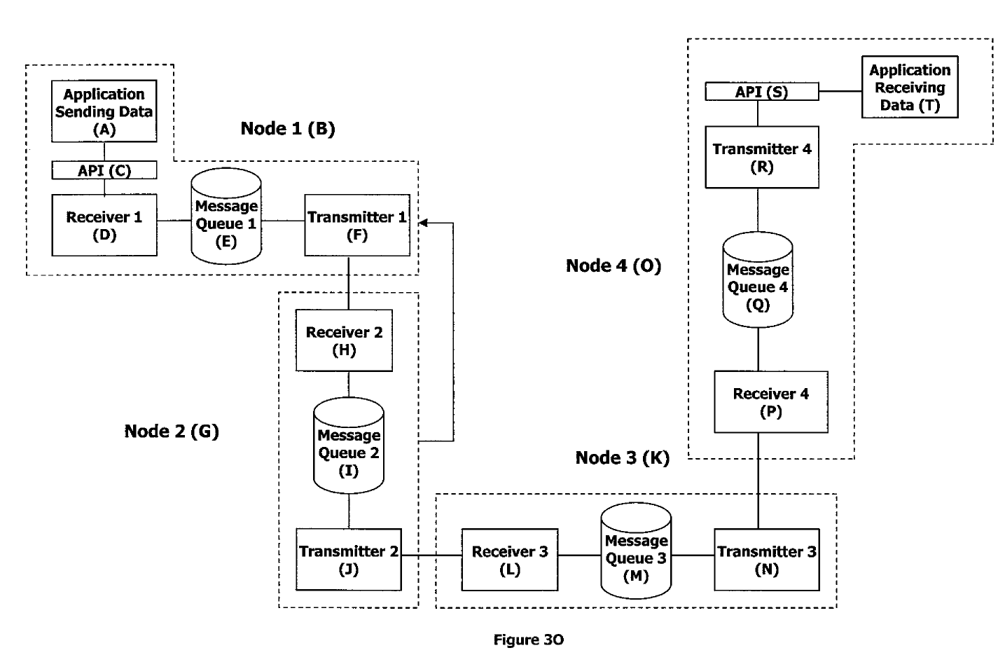

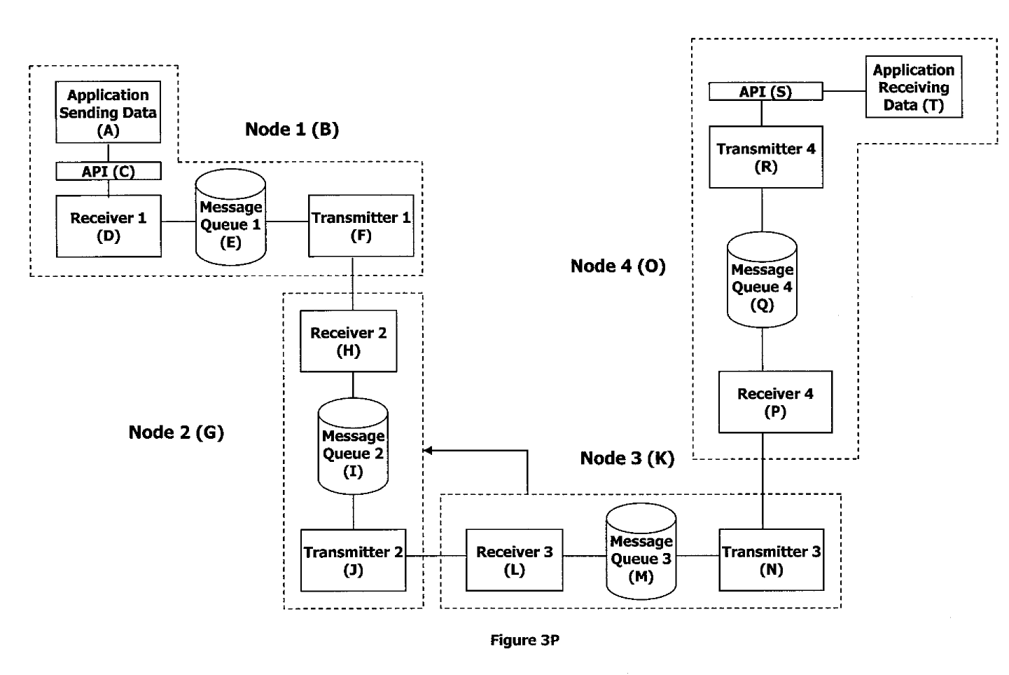

FIGS. 3A through 3P illustrates another embodiment of the present invention used to accomplish the increased reliability and speed of the fault tolerant Message Delivery System when a Transmitter on one Node cannot reach the Receiver on the next Node. This method has the ability to skip to the next intended Node and pass the message to the next reachable Node because every Node is aware of at least two known paths to every destination. When the skipped Node becomes available, a copy of the message is sent to that Receiver. The following outlines each step of the process utilized by this embodiment of the invention.

FIG. 3A—A message is sent from Application Sending Data (A) to API (C) on Node 1 (B). API (C) sends the message to Receiver 1 (D) on Node 1 (B). Receiver 1 (D) sends the message to Message Queue 1 (E). Message Queue 1 (E) sends a copy of the message to Transmitter 1 (F).

FIG. 3B—Transmitter 1 (F) on Node 1 (B) attempts to send the message to Receiver 2 (H) on Node 2 (G). However, Receiver 2 (H) on Node 2 (G) is not available and cannot be reached by Transmitter 1 (F) on Node 1 (B).

FIG. 3C—Transmitter 1 (F) on Node 1 (B) sends the message to Receiver 3 (L) on Node 3 (K). Receiver 3 (L) sends the message to Message Queue 3 (M). Message Queue 3 (M) sends a copy of the message to Transmitter 3 (N).

FIG. 3D—Node 3 (K) sends Node 1 (B) acknowledgement for receipt of the message and Node 1 (B) marks the message in Message Queue 1 (E) as acknowledged.

FIG. 3E—Transmitter 3 (N) on Node 3 (K) sends the message to Receiver 4 (P) on Node 4 (O). Receiver 4 (P) sends the message to Message Queue 4 (Q). Message Queue 4 (Q) sends a copy of the message to Transmitter 4 (R).

FIG. 3F—Node 4 (O) sends Node 3 (K) acknowledgement for receipt of the message and Node 3 (K) marks the message in Message Queue 3 (M) as acknowledged.

FIG. 3G—Node 3 (K) sends an acknowledgement to Node 1 (B) that the message is now in both Message Queue 3 (M) on Node 3 (K) and Message Queue 4 (Q) on Node 4 (O). Once acknowledgement is received by Node 1 (B), the message is marked for deletion, but is maintained in Message Queue 1 (E) on Node 1 (B) to be later sent to Receiver 2 (H) on Node 2 (G).

FIG. 3H—Transmitter 4 (R) on Node 4 (O) sends the message to API (S) on Node 4 (O). API (S) sends the message to Application Receiving Data (T).

FIG. 3I—Application Receiving Data (T) sends acknowledgement to API (S) that the message has been successfully delivered. API (S) sends acknowledgement to Node 4 (O) that the message has been successfully delivered. The message is deleted from Message Queue 4 (Q) on Node 4 (O).

FIG. 3J—Node 4 (O) sends an acknowledgement to Node 3 (K) that the message has been successfully delivered to Application Receiving Data (T). The message is deleted from Message Queue 3 (M) on Node 3 (K).

FIG. 3K—Once Node 2 (G) becomes available Transmitter 1 (F) on Node 1 (B) sends the message to Receiver 2 (H) on Node 2 (G). Receiver 2 (H) sends the message to Message Queue 2 (I). Message Queue 2 (J) sends a copy of the message to Transmitter 2 (J).

FIG. 3L—Node 2 (G) sends an acknowledgement to Node 1 (B) that the message has been successfully delivered and Node 1 (B) marks the message in Message Queue 1 (E) as acknowledged.

FIG. 3M—Transmitter 2 (L) on Node 2 (G) sends the message to Receiver 3 (L) on Node 3 (K). Receiver 3 (L) sends the message to Message Queue 3 (M). Message Queue 3 (M) sends a copy of the message to Transmitter 3 (N).

FIG. 3N—Node 3 (K) sends Node 2 (G) acknowledgement for receipt of the message and Node 2 (G) marks the message in Message Queue 2 (J) as acknowledged.

FIG. 3O—Node 2 (G) sends acknowledgement to Node 1 (B) that the message is now in Message Queue 2 (J) on Node 2 (G) and Message Queue 3 (M) on Node 3 (K). Once acknowledgement is received by Node 1 (B), the message is removed from Message Queue 1 (E).

FIG. 3P—Node 3 (K) does not send the message to Node 4 (O) since it has already been sent. Node 3 (K) sends acknowledgement to Node 2 (G). Node 2 (G) removes the message from Message Queue 2 (I).

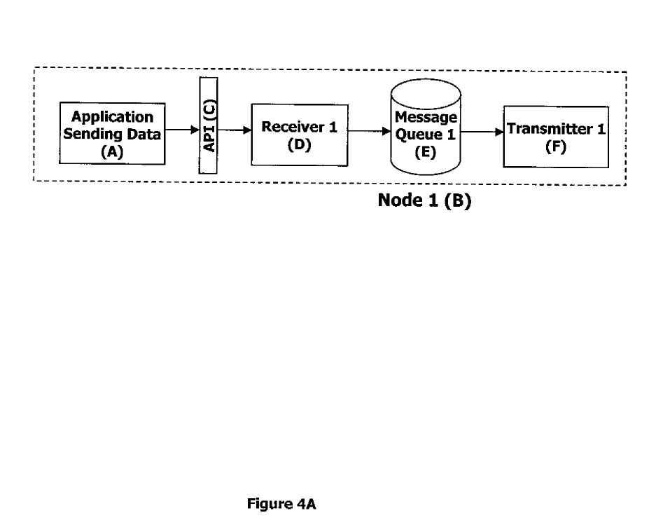

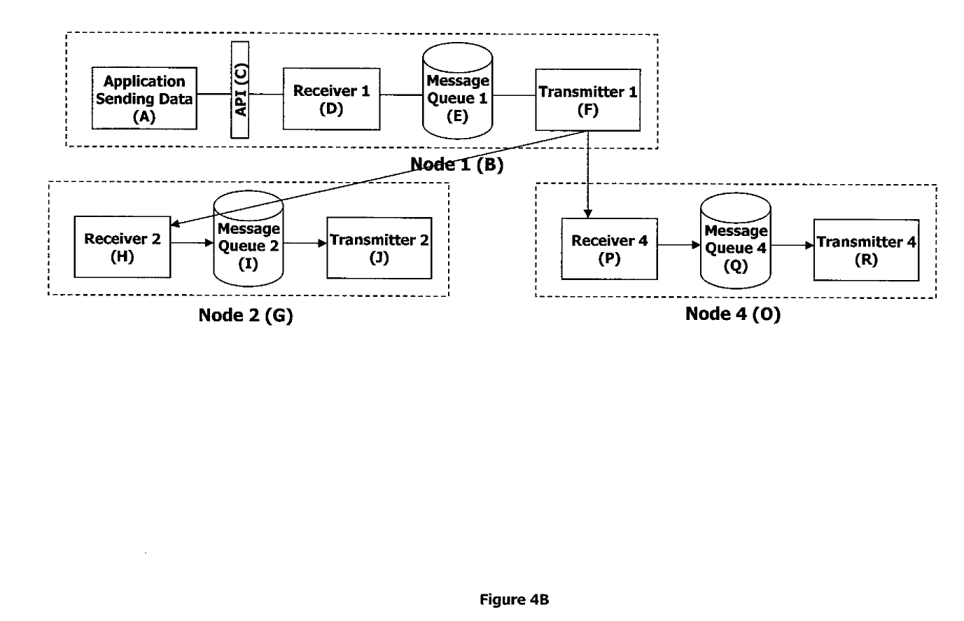

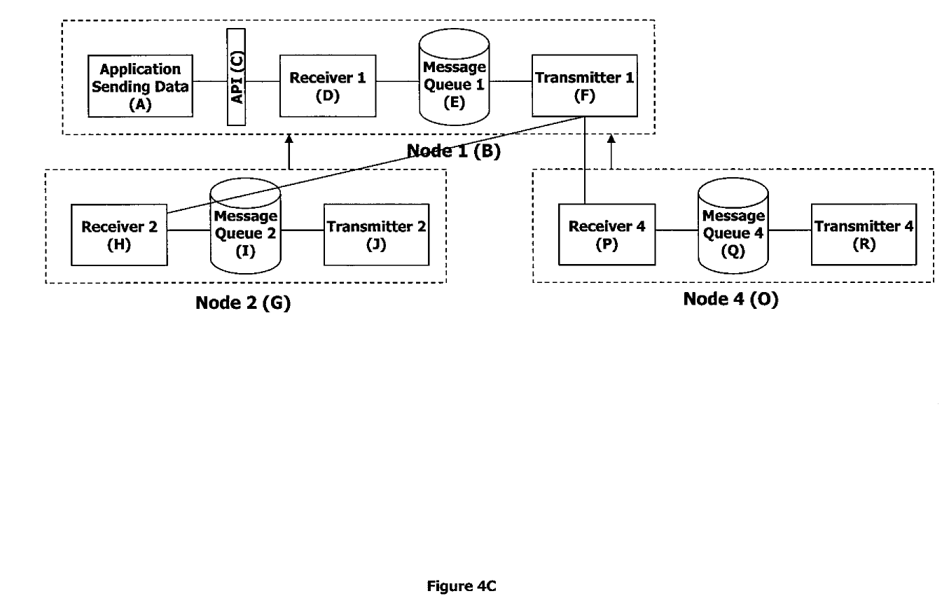

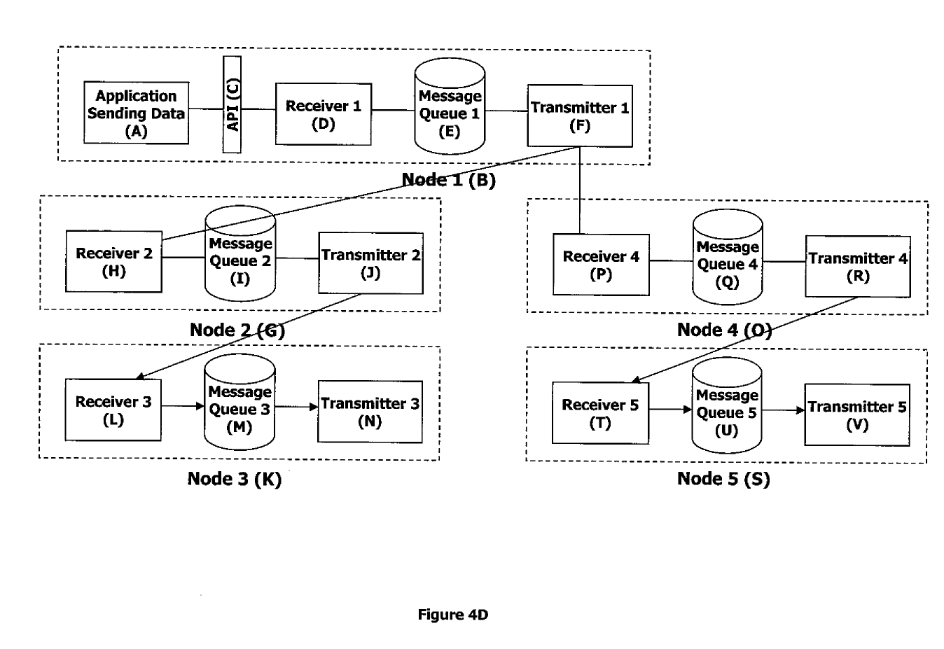

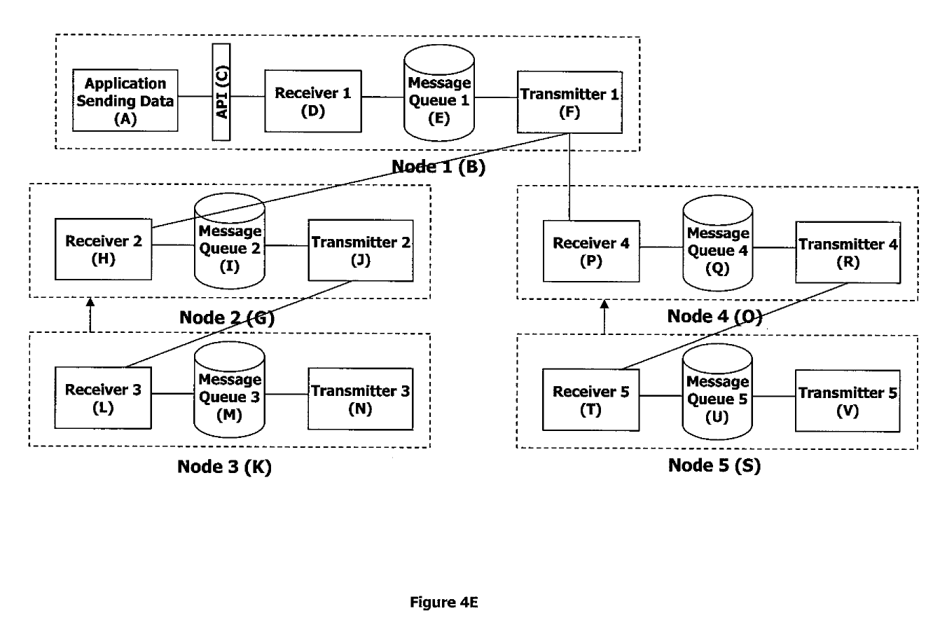

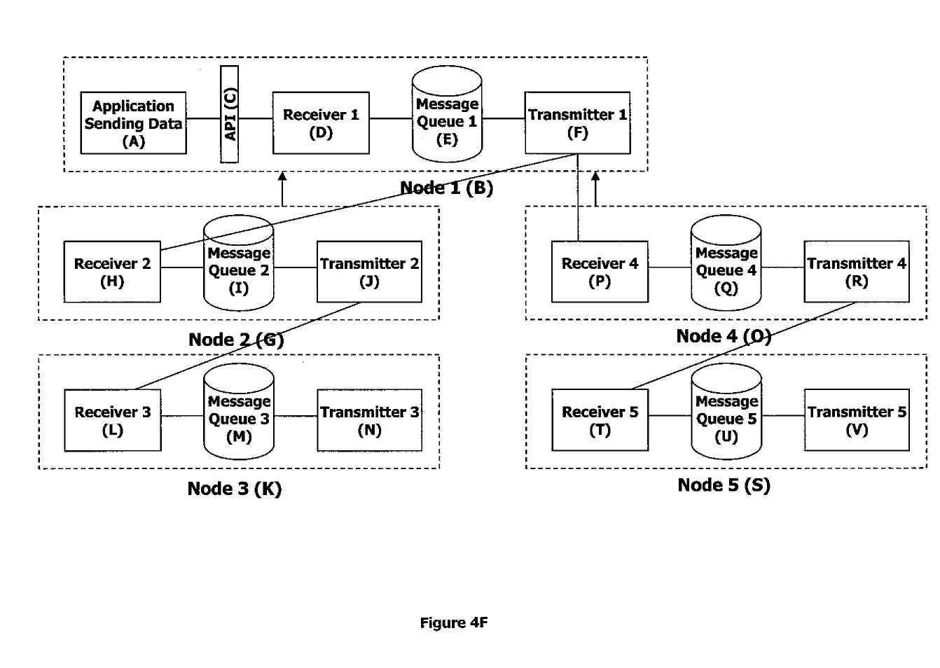

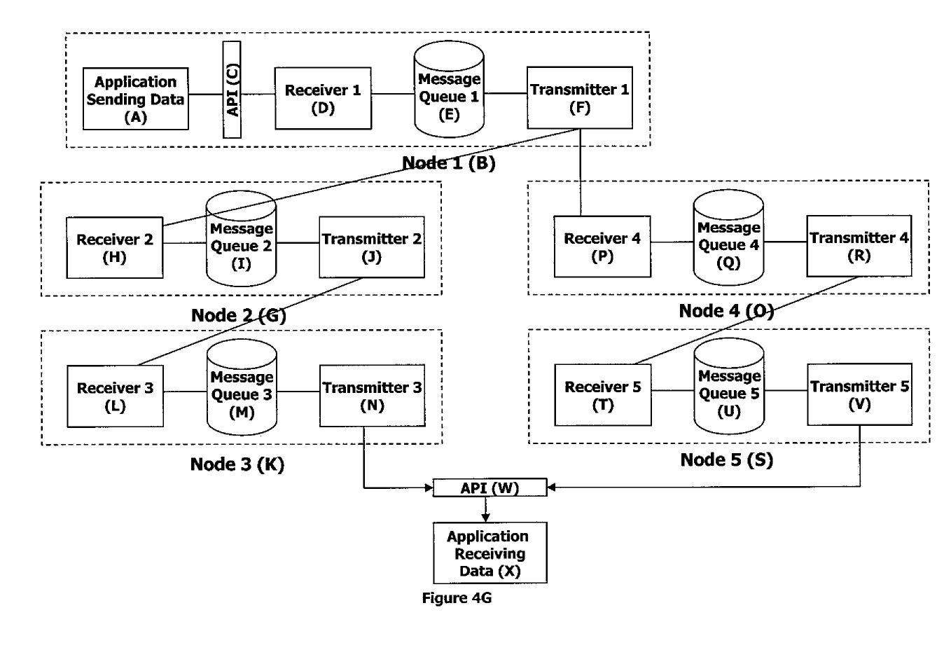

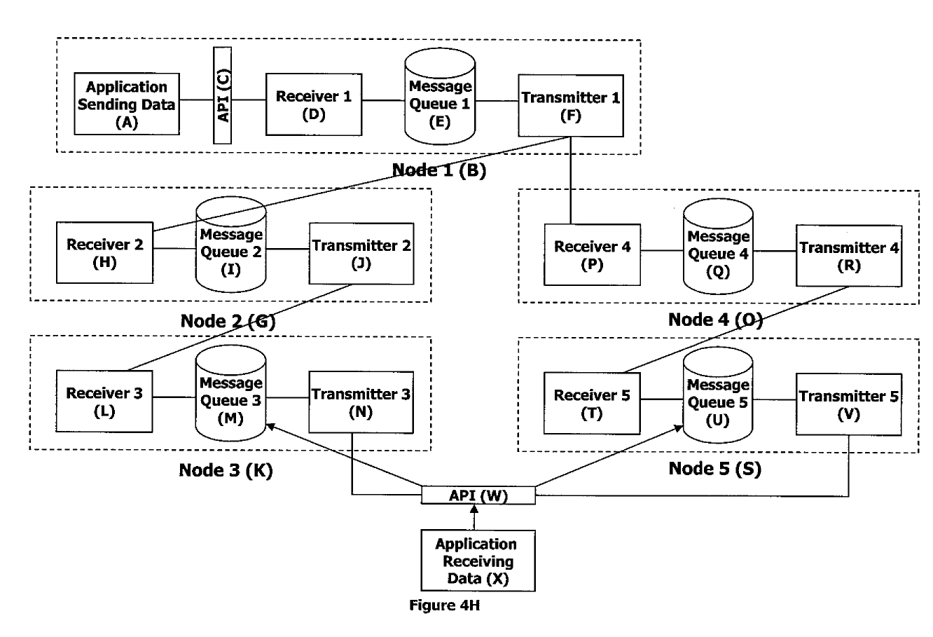

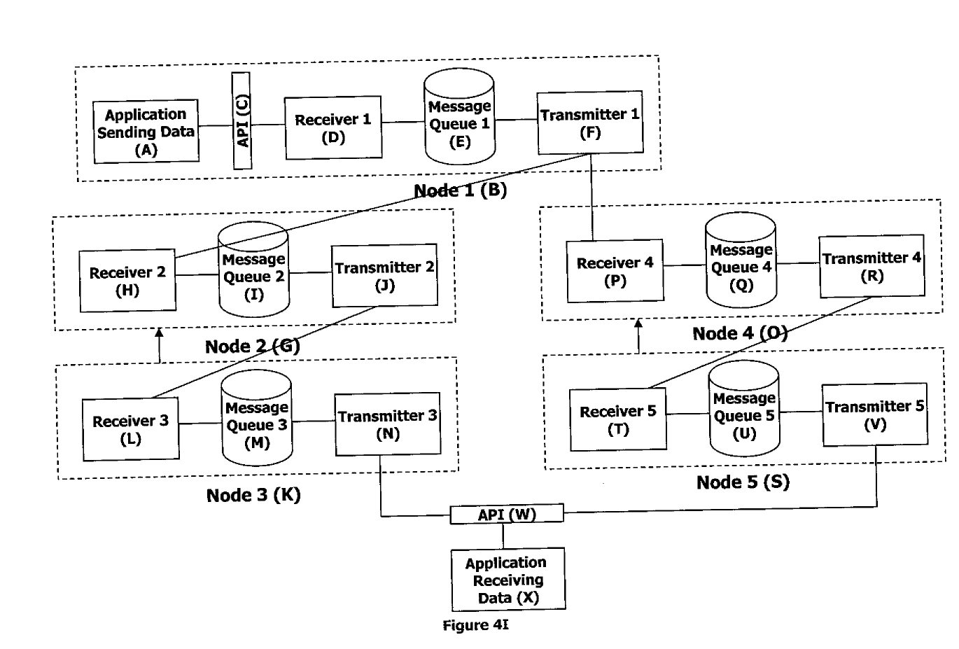

FIGS. 4A through 4I illustrate the fourth embodiment of the present invention which accomplishes the increased reliability and speed of the fault tolerant Message Delivery System. This method has the ability to send messages to multiple receivers simultaneously. Once the message has been acknowledged by at least two message queues the message is deleted from the originating message queue. The message is then propagated to the end node using the above mentioned methods of the invention. This provides the ability to quickly propagate the message to the end node even if nodes on the network are unreachable. The following outlines each step of the process utilized by this embodiment of the invention.

FIG. 4A—A message is sent from Application Sending Data (A) to API (C) on Node 1 (B). API (C) sends the message to Receiver 1 (D) on Node 1 (B). Receiver 1 (D) sends the message to Message Queue 1 (E). Message Queue 1 (E) sends a copy of the message to Transmitter 1 (F).

FIG. 4B—Transmitter 1 (F) on Node 1 (B) sends the message to Receiver 2 (H) on Node 2 (G) and Receiver 4 (P) on Node 4 (O). Receiver 2 (H) sends the message to Message Queue 2 (I). Message Queue 2 (J) sends a copy of the message to Transmitter 2 (J). Receiver 4 (P) on Node 4 (O) sends the message to Message Queue 4 (Q). Message Queue 4 (Q) sends a copy of the message to Transmitter 4 (R).

[FIG. 4C—Node 2 (G) and Node 4 (O) send Node 1 (B) acknowledgements for the receipt of the message and Node 1 (B) marks the message in Message Queue 1 (E) as acknowledged from both Segments.

FIG. 4D—Transmitter 2 (J) on Node 2 (G) sends the message to Receiver 3 (L) on Node 3 (K). Receiver 3 (L) sends the message to Message Queue 3 (M). Message Queue 3 (M) sends a copy of the message to Transmitter 3 (N). Transmitter 4 (R) on Node 4 (O) sends the message to Receiver 5 (T) on Node 5 (S). Receiver 5 (T) sends the message to Message Queue 5 (U). Message Queue 5 (U) sends a copy of the message to Transmitter 5 (V).

FIG. 4E—Node 3 (K) sends Node 2 (G) acknowledgement for receipt of the message and Node 2 (G) marks the message in Message Queue 2 (J) as acknowledged. Node 5 (S) sends Node 4 (O) acknowledgement for the receipt of message and Node 4 (O) marks the message in Message Queue 4 (Q) as acknowledged.

FIG. 4F—Node 2 (G) sends acknowledgement to Node 1 (B) that the message is now in both Message Queue 2 (J) on Node 2 (G) and Message Queue 3 (M) on Node 3 (K). Once acknowledgement is received by Node 1 (B), the message is removed from Message Queue 1 (E) only if the appropriate number of acknowledgements have been received from all Segments to which the original message was sent. Node 4 (O) sends acknowledgement to Node 1 (B) that the message is now in both Message Queue 4 (Q) on Node 4 (O) and Message Queue 5 (U) on Node 5 (S). Once acknowledgement is received by Node 1 (B), the message is removed from Message Queue 1 (E) only if the appropriate number of acknowledgements have been received from all Segments to which the original message was sent.

FIG. 4G—Transmitter 3 (N) on Node 3 (K) sends the message to API (W) and API (W) sends the message to Application Receiving Data (X), and Transmitter 5 (V) on Node 5 (S) sends the message to API (W) and API (W) sends the message to Application Receiving Data (X).

FIG. 4H—Application Receiving Data (X) sends acknowledgement to Node 3 (K) that the message has been successfully delivered. The message is deleted from Message Queue 3 (M) on Node 3 (K). Application Receiving Data (X) sends acknowledgement to API (W) and API (W) sends acknowledgement to Node 5 (S) that the message has been successfully delivered. The message is deleted from Message Queue 5 (U) on Node 5 (S).

FIG. 4I—Node 3 (K) sends acknowledgement to Node 2 (G) that the message has been successfully delivered to Application Receiving Data (X). The message is deleted from Message Queue 3 (M) on Node 3 (K). Node 5 (S) sends acknowledgement to Node 4 (O) that the message has been successfully delivered to Application Receiving Data (X). The message is deleted from Message Queue 5 (U) on Node 5 (S).

At any one time, other than the initial send from the Application Sending Data (A), the message is in at least two message queues at all times. If there is any failure at any point in the process, the messages are retrieved from any of the message queues in which they exist. With the message in at least two message queues, this prevents one message queue from losing the data and keeps the application from having to continually store the data throughout the entire process.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. In a communications system having a plurality of devices capable of communicating messages between a source and a destination, a node comprising:
a transmitter capable of sending a message over the communications system to another device;
a receiver capable of receiving a message from the communications system sent by another device; and
a queue capable of storing messages, said queue coupled to said transmitter and said receiver, said queue including logic circuitry capable of obtaining a data message from said receiver wherein a data message received is stored in said queue and an acknowledgement message is sent by said transmitter, and said logic circuitry capable of obtaining an acknowledgement message from said receiver wherein a data message stored in said queue is deleted.

2. The node of claim 1 wherein said logic circuitry is further capable of obtaining path information for a data message from said receiver wherein said transmitter sends the data message to a device indicated by the path information.

3. The node of claim 1 wherein said logic circuitry is further capable of obtaining a list of available devices from said receiver where said transmitter sends the data message to at least one of the available devices.

4. The node of claim 1 wherein said logic circuitry is further capable of obtaining an identifier from a data message wherein data messages with duplicate identifiers are deleted from said queue.

5. The node of claim 1 wherein said logic circuitry includes a clock capable of timing the storage of data messages in said queue wherein after a predetermined time period said logic circuitry will delete data messages in said queue.

6. The node of claim 1 wherein said logic circuitry is capable of sending a plurality of copies of a data message via said transmitter.

7. The node of claim 6 wherein said logic circuitry is capable of maintaining the data message in said queue until acknowledgement messages are received for each of said plurality of copies of a data message sent.

8. The node of claim 1 wherein said logic circuitry is capable of conducting point-to-point communications.

9. The node of claim 1 wherein said logic circuitry is capable of conducting asynchronous communications.

10. A method of sending a data message between devices in a communications network comprising the steps of:
receiving a data message from the communications network;
storing a copy of the data message in a queue;
transmitting a copy of the data message to another device in the communications network; and
deleting the copy of the data message in the queue when an acknowledgement message is received.

11. The method of claim 10 wherein said transmitting step includes targeting a device based on path information related to the data message.

12. The method of claim 10 wherein said transmitting step includes targeting a device based on a list of available devices.

13. The method of claim 10 where said storing step further includes the step of determining an identifier for the data message and only storing the data message if the associated identifier is not duplicative in the queue.

14. The method of claim 10 wherein said transmitting step further includes the step of timing the storage time of data messages in the queue and retransmitting data messages that are in the queue greater than a predetermined amount of time.

15. The method of claim 10 wherein said transmitting step further includes the step of transmitting a plurality of copies of the data message.

16. The method of claim 15 wherein said deleting step only occurs after an acknowledgement message is received from each copy of the data message sent.

17. The method of claim 10 wherein said receiving and transmitting steps involve point-to-point communications.

18. The method of claim 10 wherein said receiving and transmitting steps involve asynchronous communications.

19. A method for fault tolerant communications of a data message from a source computer to a destination computer where an application generates a data message on the source computer; wherein data messages are stored in volatile memory without the need for persistent storage; the source and destination computers are a part of a group of computers connected together with a communications system; comprising the steps of:
sending a data copy of the message by the source computer to at least one computer; each computer that receives the data message forwards a copy of the data message to another computer when a computer receives a copy of the message the receiving computer generates an acknowledgement message which is sent to the computer having sent the message that the acknowledgement message has been received; and
each computer that receives the acknowledgement message removes the data from its volatile memory.

20. The method of claim 19 wherein each computer that sends a message monitors how long the message has been in memory and resends that message after a configurable time period has passed.

21. The method of claim 19 wherein each message is assigned a unique number by the source computer which is used by the destination computer to identify duplicate messages.

22. The method of claim 19 wherein the destination computer reads the unique number from the received message and ignores any additional messages that have the same unique number.

23. The method of claim 19 wherein the computers in the computer grid communicate with point-to-point communications where only one computer can receive the message at the same time.

24. The method of claim 19 wherein computers in the computer grid communicate using multi-cast communications where the network allows multiple computers can receive a message sent once by the sending computer.

25. The method of claim 19 wherein the message is removed from volatile memory based on its unique message ID.

26. The method of claim 19 wherein at least one computer in the computer grid is designated as a “domain controller” where each computer in the computer grid registers its availability and communication capabilities, and receives from the domain controller asynchronously to the message delivery, a list of the computers in the computer grid and the communication link that should be utilized to communicate to each computer.
